(19) United States
(12) Patent Application Publication
(10) Pub. No.: US 2026/0119854 A1
(43) Pub. Date: Apr. 30, 2026

(54) IMPROVED GENERATIVE MACHINE LEARNING ARCHITECTURE FOR AUDIO TRACK REPLACEMENT

(71) Applicant: MONSTERS ALIENS ROBOTS ZOMBIES INC., Toronto (CA)

(72) Inventors: Daniel COHEN-OR, Hod Hasharon (IL); Ali MAHDAVI-AMIRI, North Vancouver (CA); Matthew PANOUSIS, Toronto (CA); Jonathan BRONFMAN, Toronto (CA); Lon MOLNAR, North Bay (CA); Thomas DAVIES, Toronto (CA); Ahmed Moustafa Abdelhafez HASHEM, Moncton (CA)

(21) Appl. No.: 19/483,790

(22) PCT Filed: May 13, 2024
(86) PCT No.: PCT/CA2024/050645

§ 371 Date: Nov. 12, 2025

Related U.S. Application Data
(60) Provisional application No. 63/466,240, filed on May 12, 2023.

(51) Int. Cl. G06N 3/0475; G06N 3/084; G06T 13/20; G06T 13/40; G11B 27/036

(52) U.S. Cl. CPC G06N 3/0475; G06N 3/084; G06T 13/205; G06T 13/40; G11B 27/036

(57) ABSTRACT

An improved machine learning architecture is proposed that is adapted to generate mouth regions corresponding to a target audio track that can be used, for example, in lip dubbing a base video in a first language to match a second language in the target audio track. The proposed machine learning architecture specifically includes modifications to resolve an internal mouth ambiguity problem. A number of variants are proposed along with corresponding methods and computer program products/computer readable media.

### CROSS-REFERENCE TO RELATED APPLICATIONS

This application is a non-provisional of, and claims all benefit, including priority from, U.S. Application No. 63/466,240, filed 2023 May 12, entitled “GENERATIVE MACHINE LEARNING ARCHITECTURE FOR AUDIO TRACK REPLACEMENT”.

This application is related to PCT Application No. PCT/CA2023/050068, filed 2023 Jan. 20, which was a non-provisional of U.S. Provisional Patent Application No. 63/301,947, filed 21 Jan. 2022, and U.S. Provisional Patent Application No. 63/426,283, filed 17 Nov. 2022.

### FIELD

Embodiments of the present disclosure relate to the field of machine learning for visual effects, and more specifically, embodiments relate to systems and methods for improved manipulation of lip movements in video or images, for example, to match dubbed video footage in a target language.

### Introduction

The quantity of content available on TV is rapidly expanding. Foreign movies are becoming more popular in English-speaking countries, and international streaming platforms have facilitated access to English content for non-English speakers.

To better engage audiences that speak in a language different from that of the movie in question, it is desirable to translate the movie's script and then perform dubbing. However, audio dubbing alone does not match the lip movements of speakers and may result in inconsistent timing. Therefore it is useful to manipulate the lip movements to match the dubbed movie in any given language. However, manual manipulation is not practically feasible given the immense effort required on a per-frame basis.

However, due to the uncanny valley, it is non-trivial and technically challenging to recreate a convincing visual modification that is able to survive human scrutiny. For example, a human is able to identify slight errors in modification, even if the errors are transient or only on screen for a short period of time. Because of this increased scrutiny, an improved machine learning model and approach is proposed herein to address specific technical challenges that arise in respect of computer generated replacements for visual representations of human speech in video.

### SUMMARY

As noted herein, improved approaches are proposed in respect of mechanisms for visually representing human speech in video where, for example, image portions are being transformed or otherwise replaced on specific video frames in accordance with a change in sounds being ostensibly made by a human on screen. This can be practically used, for example, in relation to generating replacement video for dubbing in different languages, changing what a person is saying (and accordingly changing the image to match the new words or sounds).

During the generation of this replacement video, the mouth features need to be replaced, such that it matches or is synchronized with what the person should be saying. The challenge level can vary as, for example, when changing someone's language from one language to another language may require the generation of images that correspond to visemes or phonemes that do not exist in the target language, or vice versa. Similarly, the mouth features are complex, and not only are there external features, such as lips, when humans generate sounds, the tongue, jaw, teeth that are involved in vocalization.

An improved approach is proposed below where, in addition or in replacement to lip landmark models, an additional encoder is proposed for tracking mouth internals, which is utilized in a machine learning architecture for adding an additional encoded input configured to improve the accuracy of reproduction of mouth internals. As described herein, more specific embodiments are also being proposed in respect of guiding conditions, masking approaches, and the use of different types of losses and tuning (e.g., hierarchical tuning) which are additional proposed mechanisms to aid in improving the technical capabilities of the system (albeit at the cost of additional computational complexity).

When generating video with mouth features replaced to correspond with new audio tracks (e.g., desired audio) or new audio instructions (e.g., desired text), there are some limitations that can arise when using two-stage models, where a first model is used to infill a masked frame according to given lip landmarks (e.g., a Lip2Face model that conditions a U-Net on lip landmarks), and a second model is used to generate landmark sequences from audio (LipPuppet), where each component is trained independently then combined for inference. Lip landmarks are often 2D points on an image that indicate (at a minimum) the left corner or mouth, right corner of mouth, top of lip, bottom of lip. Typically, lip landmarks correspond to the boundary of outer edge of lips, as well as inner edge of lips.

The limitations that arise include: issues where landmarks give no information on mouth internals, which represents a one to many problem where many mouth shapes have different tongue/teeth positions (e.g., resulting in blurry teeth/tongue in generated dub).

The generation process can also inadvertently introduce artifacts, that arise, for example, because landmarks generated by LipPuppet must match the target identity's geometry, and while Lip2Face is trained on lip landmarks matching the target identity, then in test time, the generated geometry does not match due to a domain shift (e.g., resulting in a too open/too closed/pursed lips in a generated dub).

To overcome the “internal mouth ambiguity” problem, a novel approach is proposed by Applicant, instead of having a U-Net condition generated from landmarks, a U-Net generated from a mouth crop is used instead. Internal mouth ambiguity arise when lip landmarks do not represent the internals of the mouth, but rather only the shape of the lips themselves. In other words, the mapping of audio to lip landmarks is ambiguous. This mapping is ambiguous because multiple phonemes map to the same mouth shape, but are differentiated by the mouth internals. For example, the labiodental “/f” has closed lips with teeth touching bottom, while the phoneme “/th” has slightly open lips but the tongue between teeth is visible. In landmark space, the change in landmarks is very small yet the visual appearance of the mouth is entirely different. By using a learnt representation of the mouth instead of landmarks, the network is configured to encode not only the mouth shape, but also the mouth internals. This resolves the ambiguity of mapping allowing the network to map a /f phoneme and /th phoneme to similar mouth shape, but different mouth internals.

The mouth encoder can replace or be used in place of the previous landmark encoder. In particular, the U-Net is now conditioned on an encoding of a crop of lips in target image (where before it was conditioned on the landmarks of lips in target image).

Where before LipPuppet was trained to output landmarks matching audio, the new “VectorPuppet”, which has the same or a similar underlying transform architecture, is trained to output mouth crop embeddings matching audio. In other words, the approach now utilizes training a vector puppet to encode audio tokens into the same space as the mouth encoder. A mouth crop embedding is an internally learnt representation of a given mouth shape. The mouth encoder and its predecessors has two core models. First, Lip2Face that is trained to infill a masked face with the correct mouth matching the mouth vector. Second, Voice2Lip that is trained to predict mouth vectors from audio. The details of the mouth vector are not well known as it is an implicit representation learnt by the model, similar to a variational autoencoder latent space. Mouth crop embeddings represent the details of the mouth and are strongly disentangled from the identity vectors. Therefore, one can take the mouth vector of one identity and drive another identity with it without artifacting.

As a technical improvement, Applicant has found that the textures and lip shapes are have improved relative to the earlier approach proposed in the related application. It is hypothesized that the landmark based design introduced an information bottleneck due to landmarks missing mouth internals. These bottlenecks resulted in blurry textures.

By redesigning with crop encoder, the bottleneck is removed along with the ambiguity allowing much higher quality outputs. This redesign also circumvents certain errors (i.e., noise in training) in the extracted landmarks.

In a variation, generative controls may be provided as part of a set of controllable parameters and options that can, for example, be controlled by a user or an artist to influence how the model operates. For example, both landmark and crop have the ability to intuitively influence output, and the crop encoder can be configured to provide improved controllable outputs for the user. For example, where, before, the artist was able to modify landmarks in 3D space and see the effect on output (i.e., open mouth, move mouth), the user/artist can now make changes in mouth crop vector space. The crop vector space allow arithmetic operations between embeddings for interpolation (verified). More importantly, the output of vector puppet can at any time be replaced by the embedding of a given crop image. This allows interfaces where the user might be able to “drop” an image of target mouth shape into view to change the output to be more like target mouth.

The system can be a physical computing appliance, such as a computer server, and the server can include a processor coupled with computer memory, such as a server in a processing server farm with access to computing resources.

In some embodiments, there is provided a non-transitory computer readable medium, storing machine interpretable instruction sets, which, when executed by a processor, cause the processor to perform the steps of a method according to any one of the methods above.

The system can be implemented as a special purpose machine, such as a dedicated computing appliance that can operate as part of or as a computer server. For example, a rack mounted appliance that can be utilized in a data center for the specific purpose of receiving input videos on a message bus as part of a processing pipeline to create output videos. The special purpose machine is used as part of a post-production computing approach to visual effects, where, for example, editing is conducted after an initial material is produced. The editing can include integration of computer graphic elements overlaid or introduced to replace portions of live-action footage or animations, and this editing can be computationally intense.

The special purpose machine can be instructed in accordance to machine-interpretable instruction sets, which cause a processor to perform steps of a computer implemented method. The machine-interpretable instruction sets can be affixed to physical non-transitory computer readable media as articles of manufacture, such as tangible, physical storage media such as compact disks, solid state drives, etc., which can be provided to a computer server or computing device to be loaded or to execute various programs.

In the context of the present disclosed approaches, the pipeline receives inputs for post-processing, which can include video data objects and a target audio data object. The system is configured to generate a new output video data object that effectively replaces certain regions, such as regions of the mouth regions.

Variations of computing architecture are proposed herein. For example, in an exemplar embodiment, a single U-Net is utilized that exhibits strong performance in experimental analysis.

Variations of masking approaches are also proposed, for example, an improved mask that extends the mask region into the nose region instead of just below the nose, which was also found to exhibit strong performance in experimental analysis.

The system can be practically implemented in the form of a specialized computer or computing server that operates in respect of a digital effects rendering pipeline, such as a special purpose computing server that is configured for generating post-production effects on an input video media. The input video media may include a pipeline of generated or rendered video generated for a film series, advertisements, or television series, or any other recorded content. The specialized computer or computing server can include a plurality of computing systems that operate together in parallel in respect of different frames of the input video media, and the system may reside within a data center and receive the input video media across a coupled networking bus.

### BRIEF DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a pictorial diagram showing an example lip dub system, according to some embodiments.

FIG. 2 is an illustrative diagram of a process for breaking audio into phonemes and retrieving associated visemes, according to some embodiments.

FIG. 3 is a block diagram of a disentanglement process, in which images are encoded into disentangled codes that have all the information of the images, according to some embodiments.

FIG. 4 is a block diagram of a lib dubbing process, in which the code of expression (visemes) is extracted from the audio and is added to the codes of input frames to obtain output frames, synchronized with audio segments, according to some embodiments.

FIG. 5 is a block diagram showing a disentanglement network training process, in which losses are defined on latent codes, and on images with the correct pose and expressions from a database, according to some embodiments.

FIG. 6 is an illustrative diagram of an approach for data synthesis, with different poses and expressions (visemes), according to some embodiments.

FIG. 7 is a flowchart block diagram depicting pre-processing of input video and audio.

FIG. 8 is a flowchart block diagram depicting Lip Dubber system performance, as shown in FIG. 4.

FIG. 9 is a block schematic diagram of a computational system adapted for use in video generation, according to some embodiments.

FIG. 10 is a block schematic diagram of a computer system, according to some embodiments.

FIG. 11 is a visual representation of spectrogram segments of a first audio signal wₐ being compared with the spectrogram units of a second audio signal.

FIG. 12 is a block diagram of a process used to perform lip dubbing.

FIG. 13A shows a machine learning topology diagram of an example voice-to-lip network, according to some embodiments.

FIG. 13B shows an example sequence sampler, according to some embodiments.

FIG. 14 is a machine learning topology diagram showing a voice-to-lip model configured to extract lip landmarks, audio, and an identity template from a reference video corresponding to an individual, according to some embodiments.

FIG. 15A is an example lip-to-image network, according to some embodiments.

FIG. 15B is an example lip-to-image network, according to some embodiments.

FIG. 16 is an illustrative diagram showing two images that define an inpainting area.

FIG. 17 is an example flow diagram showing face generation, according to some embodiments.

FIG. 18A and FIG. 18B is an example process flow, according to some embodiments. FIG. 18A extends onto FIG. 188.

FIG. 19 is an example block schematic of components of a system for conducting lip dubbing, according to some examples.

FIG. 20 shows an example computational process flow that can be used in a commercial practical implementation as part of a processing pipeline.

FIG. 21 is a diagram showing issues with blurred mouth internals.

FIG. 22 is shows an example architecture adapted to improve issues relating to mouth internal generation, according to some embodiments.

FIG. 23 is an example diagram showing the VectorPuppet architecture being used in conjunction with the crop encoder architecture, according to some embodiments.

FIG. 24 is a process diagram, according to some embodiments.

FIG. 25 is a diagram showing a locking of an encoder, according to some embodiments.

FIG. 26 is an alternate illustration of an example flow for using the approach for generatively creating a dub, according to some embodiments.

FIG. 27 is an example of the modified architecture of Wav2Vec2.0.

FIG. 28 is an example diagram showing the use of a blender for Lip2Face.

FIG. 29 is an example of the masking mechanisms using the proposed blender mechanism for insertion.

### DETAILED DESCRIPTION

The quantity of content available on TV is rapidly expanding. Foreign movies are becoming more popular in English-speaking countries, and international streaming platforms have facilitated access to English content for non-English speakers.

To better engage audiences that speak in a language different from that of the movie in question, it is desirable to translate the movie's script and then perform dubbing. However, audio dubbing alone does not match the lip movements of speakers and may result in inconsistent timing. Therefore it is necessary to manipulate the lip movements to match the dubbed movie in any given language.

As a result, there is a clear and growing need for systems and methods that given video V in language L and audio A, may manipulate V to obtain V′ based on audio A′ in language L′ so that the lips in V′ match audio A′. For example, audio A may be in English and audio A′ may be in French.

This presents a challenging technical problem, because video is often in a high quality and high resolution, such as 4K or greater, and a subtle mismatch or slight noise can make noticeable artifacts that should ideally be corrected and removed. As described herein, a solution is proposed to provide a system that is specially configured to generate improved video data object V′ having modified regions (e.g., a mouth region covering lips and surrounding regions).

The technical solution, in a variation, also includes a viseme synthesis step for synthesizing visemes (i.e., the mouth shapes that a person makes to produce different phonemes—i.e., /th /f /b etc. sounds that make up language and are chained to speak words—and are formed by both lip shape, tongue and teeth position) that are useful for generating V′ but are not present in original V (e.g., original audio language does not have actors making a particular lip or mouth expression for a target viseme), as well as a disentanglement step that can be used to identify the control parameters needed to send to a generator for the generation of V′ based on a set of time-coded input visemes (e.g., corresponding to A′, the audio track in the target language). Visemes are the mouth shapes a person makes to produce different phonemes. Visemes are formed by both lip shape, tongue and teeth position.

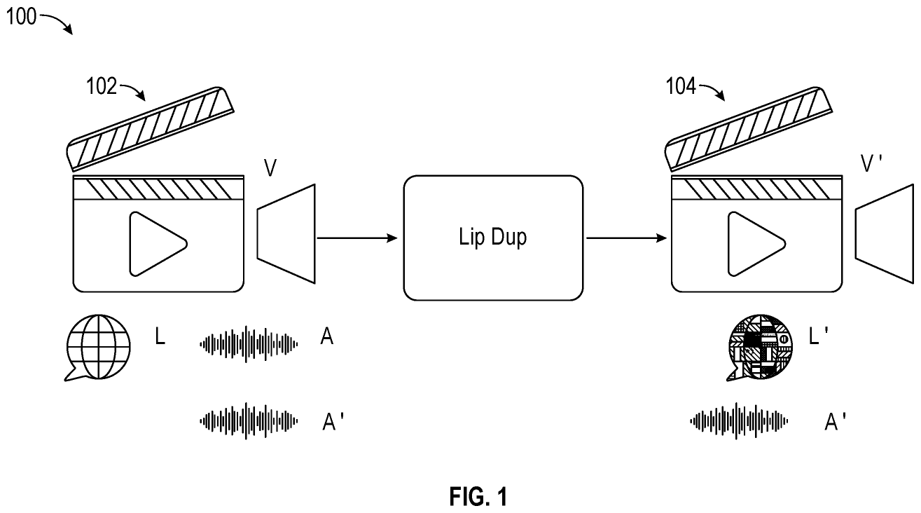

FIG. 1 is a pictorial diagram showing an example lip dub system 100, according to some embodiments.

System 100 includes input 102, with video V with audio A in language L, and audio A′ which is the translated audio A in language L′. The output result 104 is video V′ with audio A′ in language L′, arranged in a way such that frames of video V′ are matched with their respective frames of audio A′.

In some embodiments, video V includes frames F and audio A in language L, in addition to audio A′ in language L′. System 100 will manipulate frames F so that each frame I∈F is manipulated to obtain I′∈F′ that matches audio A′.

To match frames to audio segments, a deep neural network can be implemented that receives frames I∈F and its corresponding spectrogram unit s∈A′, and produces frame I′ that matches s.

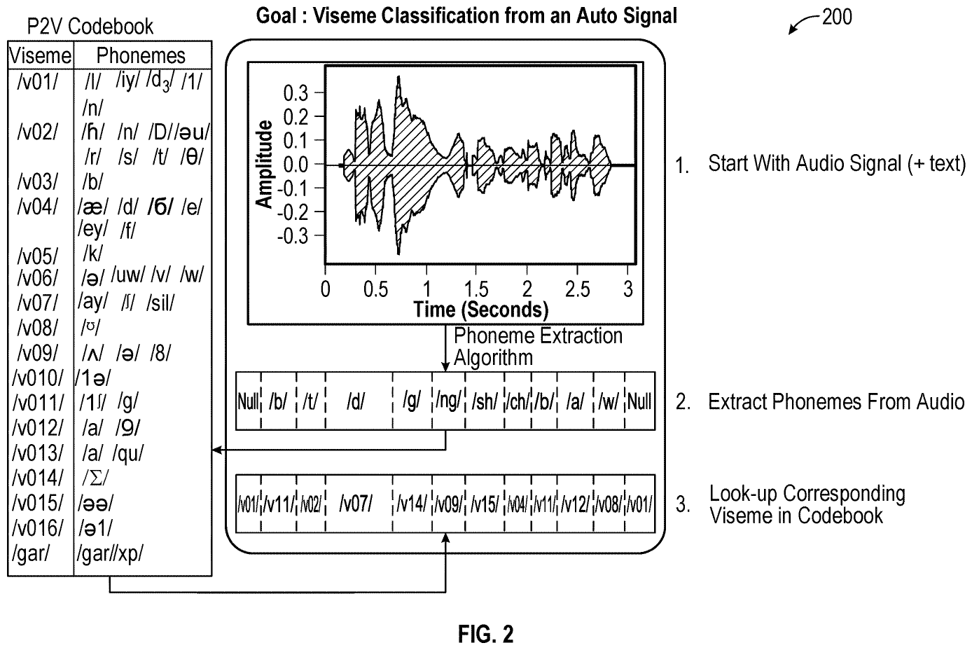

FIG. 2 is an illustrative diagram of process 200, breaking audio into phonemes and retrieving associated visemes, according to some embodiments.

In phonology and linguistics, there exist phonemes and visemes. A phoneme is a unit of sound that distinguishes one word from another in a particular language. For instance, in most dialects of English, the sound patterns /sIn/(sin) and /sIη/(sing) are two separate words which can be distinguished by the substitution of one phoneme, /n/, for another phoneme, /η/.

Again, a viseme is any of several speech sounds that look the same, for example, when lip reading. It should be noted that visemes and phonemes do not share a one-to-one correspondence. For a particular audio track, phonemes and visemes can be time-coded as they appear on screen or on audio, and this process can be automatically conducted or manually conducted. Accordingly, A′ can be represented in the form of a data object that can include a time-series encoded set of phonemes or visemes. For a phoneme representation, it can be converted to a viseme representation through a lookup conversion, in some embodiments, if available. In another embodiment, the phoneme/viseme connection can be obtained through training a machine learning model through iterative cycles of supervised training data sets having phonetic transcripts and the corresponding frames as value pairs.

Often, a single viseme can correspond to multiple phonemes because several different phonemes appear the same on the face or lips when produced. For instance, words such as pet, bell, and men are difficult for lip-readers to distinguish, as they all look like /pet/. Or phrases, such as “elephant juice”, when lip-read, appears identical to “I love you”.

As an example of time-series encoded set of phonemes, and also shown in FIG. 2, for A′, a time stamped list of phonemes labelling the entire sequence can be generated according to the phoneme detected.

Time-series encoded set of visemes are represented landmarks. For instance, for every frame in a source video (contingent on framerate of the source video), a landmark set is retrieved or generated, the set indicating a new viseme to match for that frame. If there are 600 frames in the source video, there may be 600 landmark sets. The time-series or time stamps in this case, can include frame correspondence.

Phonemes time-coding (for producing time-series encoded set of phonemes) can be seen as operating on “continuous” time space (though audio is still sampled). While visemes time-coding (for producing time-series encoded set of visemes) are coded to discrete frame space.

A phoneme to viseme (P2V) codebook can be used to classify various different phonemes with their corresponding visemes. The P2V codebook, for example, could be a data structure representing a lookup table that is used to provide a classification of phoneme with a corresponding viseme. The classification is not always 1:1 as a number of phonemes can have a same viseme, or similarly, contextual cues may change a viseme associated with a particular phoneme. Other properties of the face (e.g., angriness) can be preserved by disentangling viseme from other properties of the image.

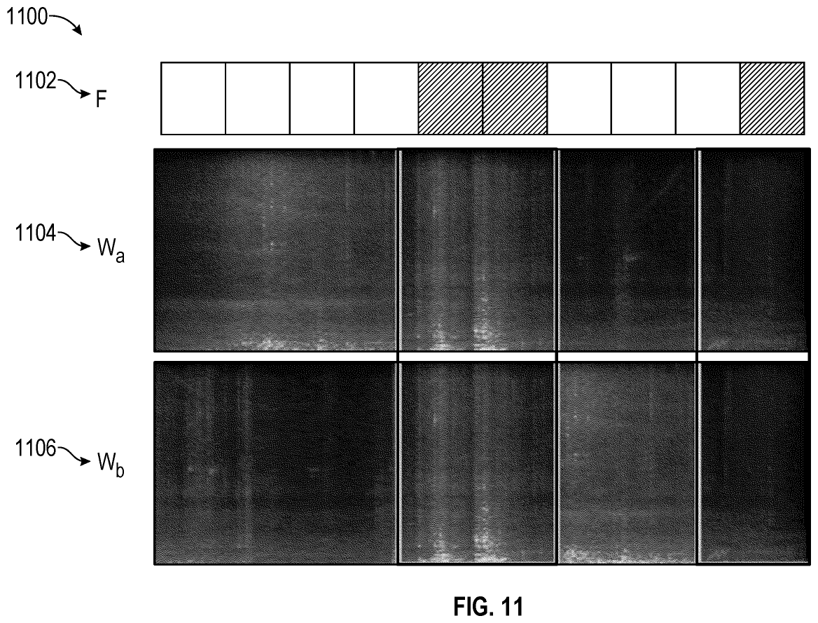

Starting with audio signal A as well as the related text, audio A is broken into segments sᵢ to find corresponding phoneme pᵢ. From pᵢ, a corresponding viseme vᵢ is determined or extracted. If the desired visemes and poses are available in an input video (see FIG. 11), they can be retrieved from the original input, otherwise they may need to be generated as described herein using a proposed disentanglement model. In some embodiments, desired visemes can also be obtained from a library associated with a particular actor or character in other speaking roles in other videos.

Visemes are added to a viseme database that may be synthesized beforehand, described further below.

Ideally, any lip movement could be constructed by combining images representing these visemes.

However, such images that portray a specific viseme vary in pose, lighting conditions, among other varying factors. As a result, a mechanism to manipulate these frames to match them to specific visemes (expressions), poses, lighting conditions, among other varying factors, can be applied.

In some embodiments, the process includes classifying visemes or learn a code for each image. Then, by replacing one code and changing others, the machine learning model architecture ideally only ends up changing one aspect of the image (e.g., the relevant mouth region).

A code may be a vector of length N. Depending on the machine learning model architecture, which can include a generator network such as StyleGAN, the length N and how the code is determined may differ.

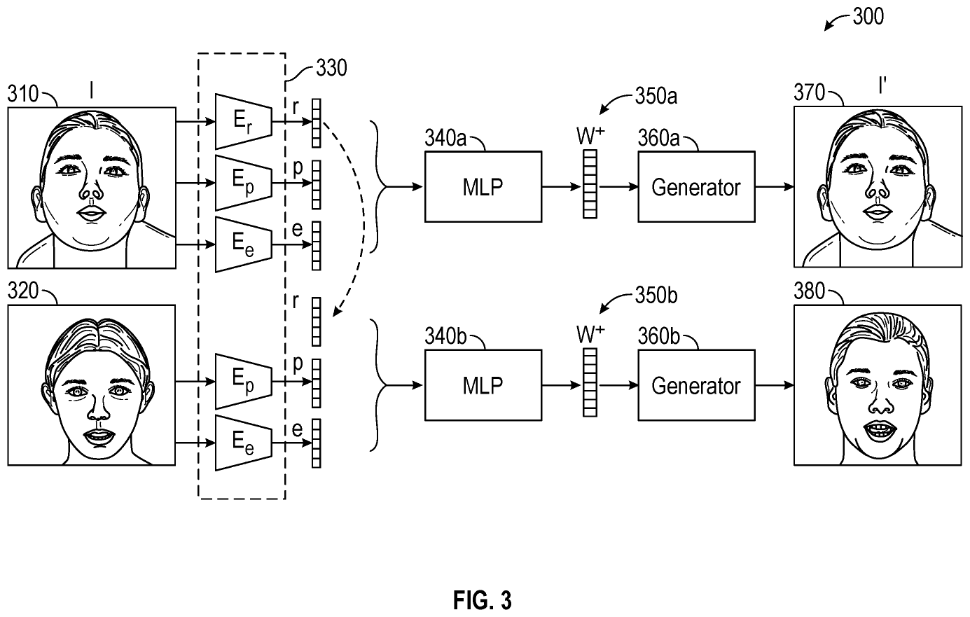

For instance, an example of a learned code is shown as w⁺ in FIG. 3. The machine learning model architecture may learn a code by finding some code that when given to the generator network, produces the same image.

Then the machine learning model architecture is trained to find the modification required to that code to generate the desired viseme while maintaining all other properties of the image. When modifying the image, a code for an “open mouth” shape of a person in the image should not make the hair red.

As a non-limiting example of process 200, audio with text may be received, and phonemes extracted from said received audio. These identified phonemes may then be assigned the appropriate viseme, which can be done using a suitable P2V codebook to look-up the corresponding visemes.

Each frame I∈F is composed of expression e that contains the geometry of the lips and mouth (i.e., visemes) and texture, an identification string or number (ID) that distinguishes one individual from the other, along with a pose p that specifies the orientation of a face.

In dubbing applications, only relevant facial expressions may be modified according to spectrogram s, while pose p and everything else (residual r) may be kept intact. Therefore, the core neural network learns to disentangle e, r, and p from I.

FIG. 3 is a block diagram of disentanglement 300, in which images are encoded into disentangled codes that retain all the information of the images, according to some embodiments.

Disentanglement is a technique that breaks down, or disentangles, features into narrowly defined variables and encodes them as separate dimensions. The goal of disentanglement is to mimic quick intuitive processes of the human brain, using both “high” and “low” dimension reasoning.

In the shown example embodiment, disentanglement 300, image frames 310, 320 are processed, by a plurality of encoders 330, into three disentangled codes representing pose, expression (viseme), and residuals, that have all the information of the images. To train, identity should be preserved as well as paired images with the same pose, identity, or ID. Paired data used for disentanglement can be encapsulated or represented in different forms (e.g., vector, integer number, 2D/3D points, etc.). In some embodiments, the approach includes an intentional overfitting to the input video achieve improved results.

The non-limiting described neural network uses three encoders that are used to disentangle expression e, and pose p from other properties of the images including ID, background, lighting, among other image properties. The codes of these image properties are integrated into a code w⁺ 350a, 350b via a multilayer perceptron (MLP) network 340a, 340b. w⁺ 350a, 350b may be passed to a pre-trained generator 360a, 360b, such as StyleGAN, to generate a new image I′ 370, 380.

A MLP network 340a, 340b is a type of neural network, and are comprised of one or more layers of neurons. Data is fed to the input layer, then there may be one or more hidden layers which provide levels of abstraction, then predictions are made on an output layer, or the “visible layer”.

The encoders 330 and the MLP network 340a, 340b may be trained on identity tasks, meaning that I and I′ are the same, as well as on a paired data set for which I and I′ are paired and they differ in one or two properties, such as ID, pose, or expression, for example. For the purpose of lip dubbing, expressions may be taken from the viseme database. During output video generation, I′ may be either full images or selected mouth regions, and either can be inserted to generate the replacement video frames. Inserting just the mouth regions could be faster and less computationally expensive, but it could have issues with bounding box regions and incongruities in respect of other aspects of the video that are not in the replacement region.

Training is described with further detail below.

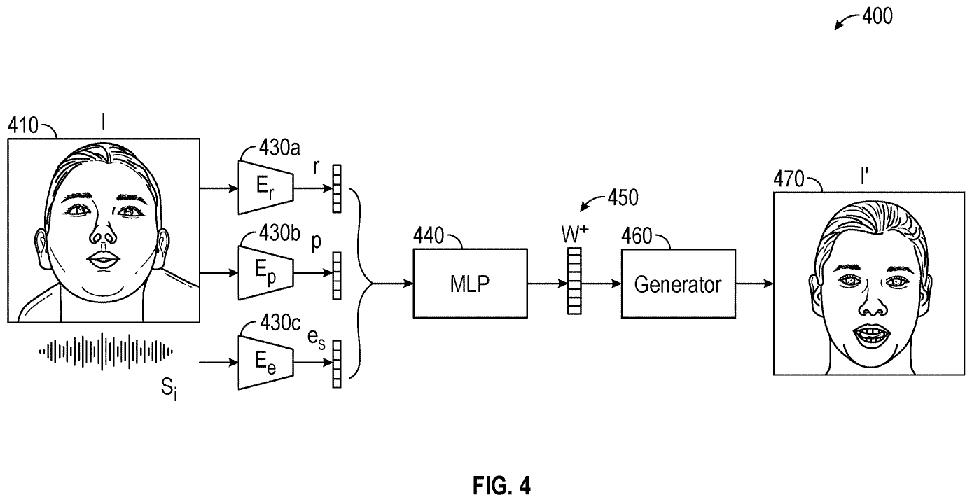

FIG. 4 is a block diagram of lib dubbing process 400, in which the code of expression (visemes) is extracted from the audio and is added to the codes of input frames to obtain output frames, synchronized with audio segments, according to some embodiments.

The codes of input frames here can be generated using a latent space inversion (or encoding) process.

Modification to the vector or the code allows semantic modification of the image when passed back through a generator. For example, moving along the “age” direction represented by the vector in latent space will age the person in the generated image.

An image frame 1410 are processed, by a plurality of encoders 430a, 430b, 430c, into three disentangled codes representing pose p, expression (viseme) e, and residuals r, that have all the information of the images.

The non-limiting embodiment process 400 herein implements three encoders 430a, 430b, 430c that are used to disentangle expression e, and pose p from other properties of the images including ID, background, lighting, among other image properties. The codes of these image properties are integrated into a code w⁺ 450 via a MLP network 440. w⁺ 450 may be passed to a pre-trained generator 460, such as StyleGAN, to generate a new image I′ 470.

In some embodiments, a separate audio track for each individual character is obtained (or extracted from a combined audio track). Heads and faces, for example, can be identified by using a machine learning model to detect faces to establish normalized bounding boxes. Distant and near heads may have different approaches, as near heads may have a larger amount of pixels or image regions to modify, whereas more distant heads have a smaller amount of pixels or image regions to modify.

To perform the lib dubbing process 400 shown in the example embodiment, the code of expressions (visemes) is extracted from the audio and is added to the codes of frame I to obtain frame I′ that is synchronized with audio segment.

To perform lip dubbing, audio A′ goes through a viseme identification process, such that a viseme can be found for each spectrogram segment sᵢ. The system can be configured to map audio to phonemes and then map phonemes to visemes.

For example, 19 visemes can be considered and indexed by a single unique integer (1-19). Spectrogram sᵢ may then be passed to another encoder or a separate module (such as a phoneme to viseme module) to produce an expression/viseme code from sᵢ called eₛ. Input video may or may not have the viseme in the same pose as I. If V already has the same viseme and pose, it can simply be retrieved (see FIG. 11). If not, first I is encoded into three latent codes containing eₛ, r, and p. Then, instead eₛ, r, and p are passed to a decoder to generate a new frame I′ that preserves ID, pose, among others, while it matches the expression eₛ coming from the audio.

In some embodiments, it may be possible to only take the mouth region from I′ and insert it into I and perform an image harmonization to generate a smooth result.

It should be noted that latent codes can be of any size or form, including hot code, single integer value, or a vector of floats in any size.

In other embodiments, it may be preferable to reproduce the entire I′ or to create only the lip shape and insert that back into I.

In addition, if the right pose and expression are already available in the input video V, the appropriate frame may simply be retrieved from video V. In cases where such a frame does not exist, a new frame may be generated using the discussed process. The described example generator may be likely to use a StyleGAN, or a variation thereof.

In some embodiments, an additional feedback process is contemplated using a lip reading engine that automatically produces video/text of the output, which is then fed back to the system to compare against the input to ensure that the output video is realistic.

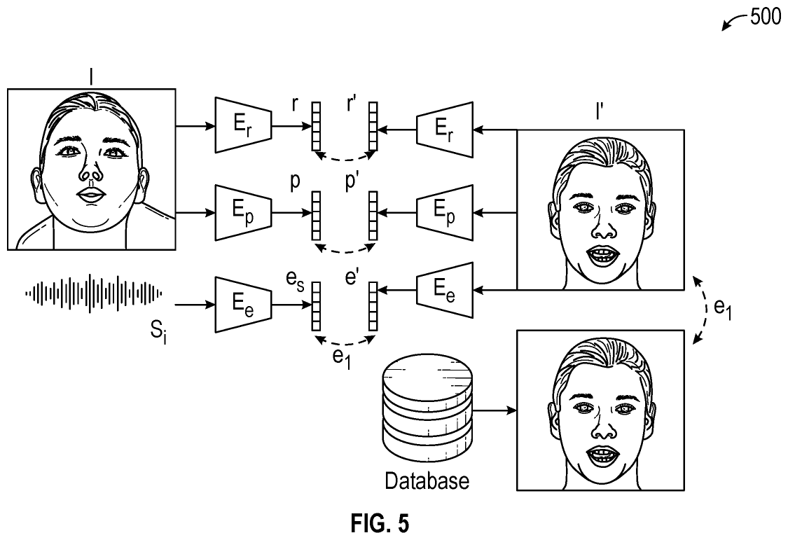

FIG. 5 is a block diagram of disentanglement network training process 500, in which losses are defined on latent codes, and on images with the correct pose and expressions from a database, according to some embodiments.

For training process 500, of what may be the first disentanglement network, according to some embodiments, I and I′, have been paired, and have been improved in terms of realism through pSp.

Pixel2style2pixel (pSp) is an image-to-image translation framework. The pSp framework provides a fast and accurate solution for encoding real images into the latent space of a pre-trained StyleGAN generator. In addition, the pSp framework can be used to solve various image-to-image translation tasks, such as multi-modal conditional image synthesis, facial frontalization, inpainting and super-resolution, among others.

In some embodiments, pSp may be used to map images created in a synthetic environment with different visemes, poses and textures, to realistically looking images.

To do so, synthetic images may be fed to pSp and generate code w₀.

In further embodiments, a code may also be sampled in the realistic domain called w₁. By mixing top entries of w₀ with bottom entries of w₁, expressions (e.g., viseme) and pose of the synthetic image captured in w₀ may be preserved, and produce realistic images with appearance similar to the realistic image with code w₁. By sampling different images and producing various w₁, some embodiments may produce an abundant number of labeled realistic images in certain poses and visemes dictated by the synthetic data. This labeled realistic data may be used for learning disentanglement.

Loss L₁ (e.g., |xi−xj|) can be defined on the result and ground truth. I′ can also be fed back to the video encoder to obtain r′, p′, and e′ and compare them against the input codes. To do so, a loss L₁ can be defined on r′, p′, and e′ against i, p, and eₛ. To ensure that the new lips are valid, the closest image with r, p, and eₛ in the database should be retrieved.

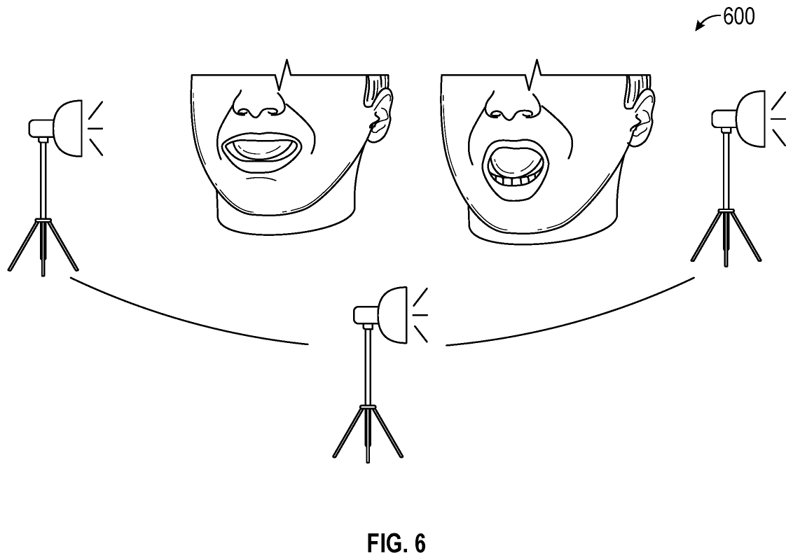

FIG. 6 is a illustrative diagram of data synthesis 600, with different poses and expressions (visemes), according to some embodiments.

To disentangle different properties of frames, relevant datasets are needed. To generate such datasets, data can be synthesized with different identities that are rendered at different poses and expressions. These expressions include all the available visemes that may be needed to produce an effective lip dub.

The uncanny valley in aesthetics, is a hypothesized relation between an object's degree of resemblance to a human being and the emotional response to said object. The hypothesis suggests that humanoid objects that imperfectly resemble actual humans provoke “uncanny” familiar feelings of eeriness and revulsion in observers. The “valley” refers to a sharp dip in a human observer's affinity for the replica, which otherwise increases with the replica's human likeness. For example, certain lifelike robotic dolls, which appear almost human, risk eliciting cold, eerie feelings in viewers.

To overcome the uncanny valley, and produce more realistic images, the synthetic datasets will be fed to pSp to produce natural images with different IDs.

Thus, according to some embodiments, the described systems learn to disentangle expressions (visemes and lip shapes) from other properties such as pose, lighting, and overall texture. Therefore, data is needed to learn how to disentangle these properties.

Further embodiments realistically synthesize missing visemes. This is needed when the correct viseme is not available in the input video. This may be particularly useful when the input video is short. According to some embodiments, this is done by leveraging the system to generate synthetic data in different poses and IDs, and the extra steps, described above in data synthesis 600, may be performed to make them more realistic.

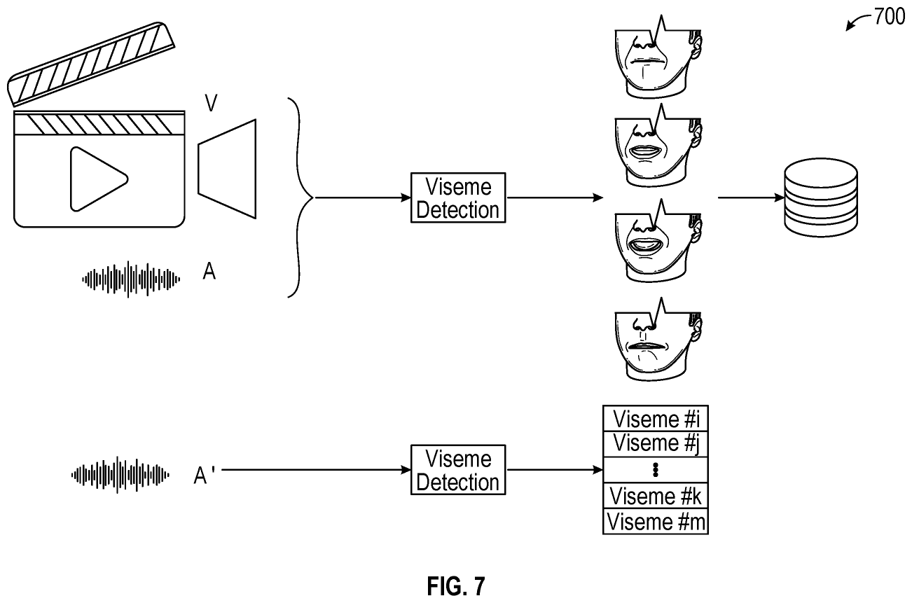

FIG. 7 is a flowchart block diagram 700 depicting pre-processing of input video and audio.

In some embodiments, lip dubbing may be composed of two parts. Flowchart 700 depicts part one, pre-processing. In pre-processing, visemes of the input 102 are found and added to the database. Audio A′ is processed to identify the viseme codes of its audio segments.

Part two according to said embodiment involves lip dubbing.

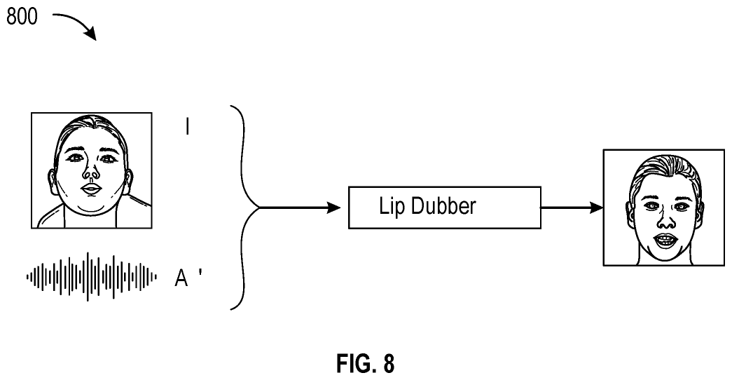

FIG. 8 is a flowchart block diagram 800 depicting Lip Dubber performance, as shown in FIG. 4. According to viseme codes of audio A′, the Lip Dubber depicted in FIG. 4 may be used to modify frames of video V.

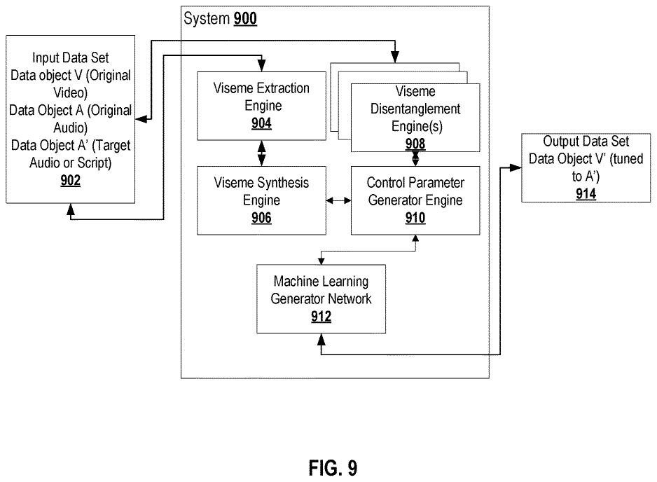

FIG. 9 is a block schematic diagram of a computational system 900 adapted for use in video generation, according to some embodiments.

The system can be implemented by a computer processor or a set of distributed computing resources provided in respect of a system for generating special effects or modifying video inputs. For example, the system can be a server that is specially configured for generating lip dubbed video outputs where input videos are received and a translation subroutine or process is conducted to modify the input videos to generate new output videos.

As described above, the system 900 is a machine-learning engine based system includes various maintained machine learning models that are iteratively updated and/or trained, having interconnection weights and filters therein that are tuned to optimize for a particular characteristic (e.g., through a defined loss function). Multiple machine learning models may be used together in concert, for example as described herein, a specific set of machine learning models may be first used to disentangle specific parameters for ultimately controlling a video generator hallucinatory network.

The computational elements shown in FIG. 9 are shown as examples and can be varied, and more, different, less elements can be provided. Furthermore, the computational elements can be implemented in the form of computing modules, engines, code routines, logical gate arrays, among others, and the system 900, in some embodiments, is a special purpose machine that is adapted for video generation (e.g., a rack mounted appliance at a computing data center coupled to an input feed by a message bus).

This system can be useful, for example, in computationally automating previously manual lip dubbing/redrawing exercises, and overcome issues relating to prior approaches are lip dubbing, where the replacement voice actors/actresses in the target language either had to match syllables with the original lip movements (resulting in awkward timing or scripts in the target language), or have on screen lip movements that do not correspond properly with the audio in the target language (the mouth moves but there is no speech, or there is no movement but the character is speaking).

An input data set is obtained at 902, for example, as a video feed provided from a studio or a content creator, and can be provided, for example, as streamed video, as video data objects (e.g., .avi, .mp4, .mpeg). The video feed may have an associated audio track that may be provided separately or together. The audio track may be broken down by different audio sources (e.g., different feed for different on-screen characters from the recording studio).

A target audio or script can be provided, but in some embodiments, it is not provided and the target audio or script can be synthesized using machine learning or other generative approaches. For example, instead of having new voice actors speak in a new language, the approach obtains a machine translation and automatically uses a generated voice.

The viseme extraction engine 904 is adapted to identify the necessary visemes and their associated timecodes from the target audio or script. These visemes can be extracted from phonemes in some examples, if phonemes are provided, or extracted from video using a machine learning engine. The visemes can be mapped to a list of all visemes and stored as tuples (e.g., viseme 14, t=0.05-0.07 s, character Alice; viseme 13, t=0.04-0.08 s, character Bob).

The viseme synthesis engine 906 is configured to compare the necessary visemes with the set of known visemes from the original video data object, and conduct synthesis as necessary of visemes missing from the original video data object. This synthesis can include obtaining visemes from other work from a same actor, generating all new mouth movements from an “eigenface”, among others.

The viseme disentanglement engine(s) 908 is a set of machine learning models that are individually tuned to decompose or isolate mouth movement-related movements associated with various visemes when controlling the machine learning generator network 912, which are then used to generate control parameters using control parameter generator engine 910.

The machine learning generator network 912 (e.g., StyleGAN or another network) is then operated to generate new frame objects whenever a person or character is speaking or based on viseme timecodes for the target visemes. The frame objects can be partial or full frames, and are inserted into V to arrive at V′ in some embodiments. In some embodiments, instead of inserting into V, V′ is simply fully generated by the machine learning generator network 912.

An output data set 914 is provided to a downstream computing mechanism for downstream processing, storage, or display. For example, the system can be used for generating somewhat contemporaneous translations of an on-going event (e.g., a newscast), movie/TV show/animation outputs in a multitude of different languages, among others. In another embodiment, the output data set 914 is used to re-dub a character in a same language (e.g., where the original audio is unusable for some reason or simply undesirable). Accents may also be modified using the system (e.g., different English accents, Chinese accents, etc. may be corrected).

For example, the output data set 914 can be used for post-processing of animations, where instead of having initial faces or mouths drawn in the original video, the output video is generated directly based on a set of time-synchronized visemes and the mouth or face regions, for example, are directly drawn in as part of a rendering step. This reduces the effort required for preparing the initial video for input.

In yet another further example, the viseme data is provided and the system that generates video absent an original input video, and an entirely “hallucinated” video based on a set of instruction or storyboard data objects is generated with correct mouth shapes and mouth movements corresponding to a target audio track.

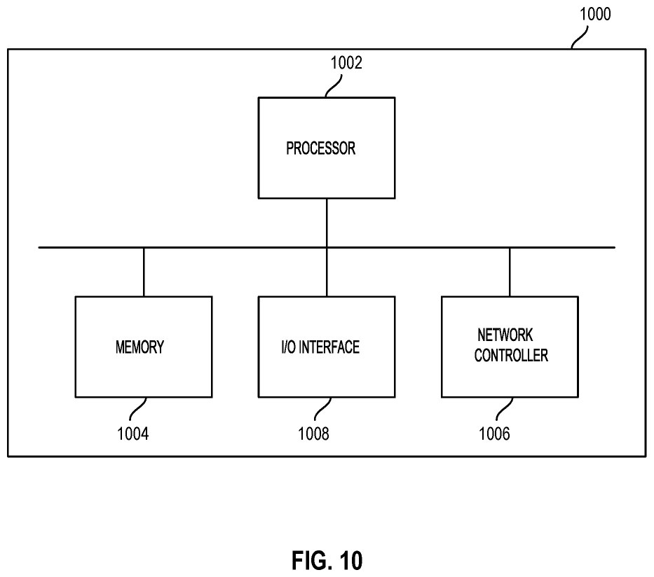

FIG. 10 is an example computational system, according to some embodiments. Computing device 1000, under software control, may control a machine learning model architecture in accordance with the block schematic shown at FIG. 9.

As illustrated, computing device 1000 includes one or more processor(s) 1002, memory 1004, a network controller 1006, and one or more I/O interfaces 1008 in communication over a message bus.

Processor(s) 1002 may be one or more Intel x86, Intel x64, AMD x86-64, PowerPC, ARM processors or the like.

Memory 1004 may include random-access memory, read-only memory, or persistent storage such as a hard disk, a solid-state drive or the like. Read-only memory or persistent storage is a computer-readable medium. A computer-readable medium (e.g., a non-transitory computer readable medium) may be organized using a file system, controlled and administered by an operating system governing overall operation of the computing device.

Network controller 1006 serves as a communication device to interconnect the computing device with one or more computer networks such as, for example, a local area network (LAN) or the Internet.

One or more I/O interfaces 1008 may serve to interconnect the computing device with peripheral devices, such as for example, keyboards, mice, video displays, and the like. Such peripheral devices may include a display of device 120. Optionally, network controller 1006 may be accessed via the one or more I/O interfaces.

Software instructions are executed by processor(s) 1002 from a computer-readable medium. For example, software may be loaded into random-access memory from persistent storage of memory 1004 or from one or more devices via I/O interfaces 1008 for execution by one or more processors 1002. As another example, software may be loaded and executed by one or more processors 1002 directly from read-only memory.

Example software components and data stored within memory 1004 of computing device 1000 may include software to perform machine learning for generation of hallucinated video data outputs, as disclosed herein, and operating system (OS) software allowing for communication and application operations related to computing device 1000.

In accordance with an embodiment of the present application, a video V (image frames F+voice wₐ) is given in language L (e.g., English) along with a voice w_{b} in language L′ (e.g., French) are given. FIGS. 11-17 illustrate various processes that may be used to replace the lip shapes in video V according to the voice in language L′.

FIG. 11 is a visual representation 1100 of spectrogram segments of a first audio signal wₐ being compared with the spectrogram units of a second audio signal. F 1102 shows an example set of timestamped frames.

The first audio wₐ signal 1104 may be the audio signal of audio A′ in language L′. The second audio signal w_{b} 1106 may be the audio signal of audio A in language L in the input video V. Each of the spectrogram segments of the second audio signal w_{b} may have a known viseme and pose that may be obtained from the input video V. The audio signal wₐ may be aligned with audio signal w_{b} to identify the spectrogram segments of second audio signal w_{b} that are the same as first audio signal wₐ.

The audio signal wₐ may be aligned with audio signal w_{b} to determine corresponding visemes for spectrogram segments of second audio signal w_{b}. As illustrated in the depiction, certain spectrogram segments of first audio signal wₐ may be the same as certain spectrogram segments of second audio signal w_{b} (green frames shown in FIG. 11). For each common spectrogram segment, the known viseme and pose corresponding to the spectrogram segment of the first audio signal may be retrieved and used to determine the viseme and pose of the spectrogram unit of the second audio signal.

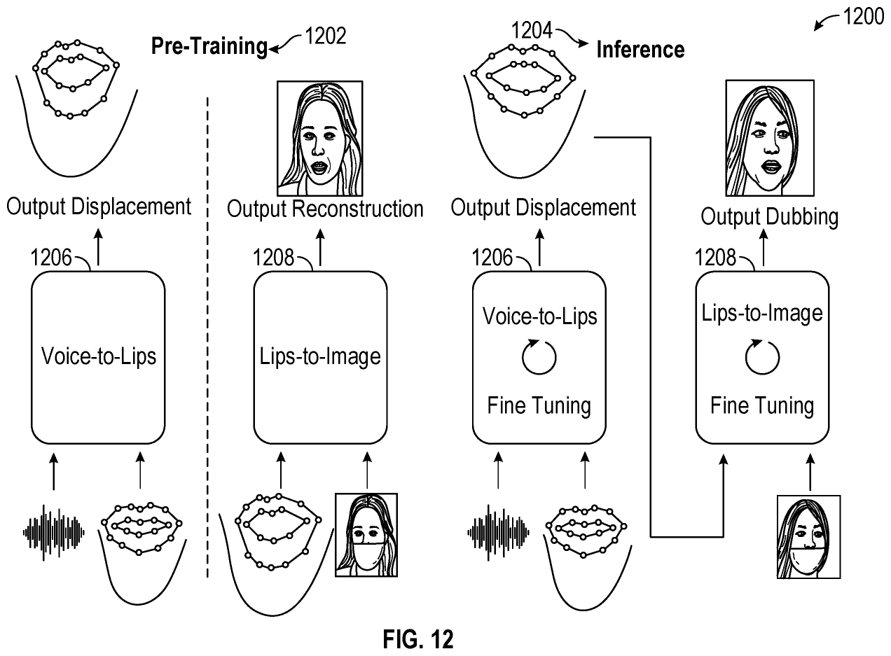

In some embodiments, the frames of video V that match these common spectrogram units may be copied from video V and used in the generation of video V. For the remaining spectrum segments where there is no commonality, the processes shown in FIG. 12 may be used.

This is an optional step that can be used to bypass certain similar frames to reduce overall computational time. For example, a sample output from this stage could be identified segments requiring frame generation (e.g., identified through timeframes or durations). As an example, these segments could be representative of all of the frames between two time stamps. For example, there may be a video where there is speech between two people from t=5 s to t=6 s. However, it is identified that there are similar frames for certain speech from t=5.00 s-t=5.3 s, and from t=5.5 s-t=6.0 s. Accordingly, the frames from t=5.3 s-t=5.5 s can be inserted into a processing pipeline from generation to generate frame portions that represent the replacement mouth portions for these frames. Each of the frames could be processed using the two trained networks together to replace the mouth portions thereof as described below.

FIG. 12 is a block diagram 1200 of a process used to perform lip dubbing.

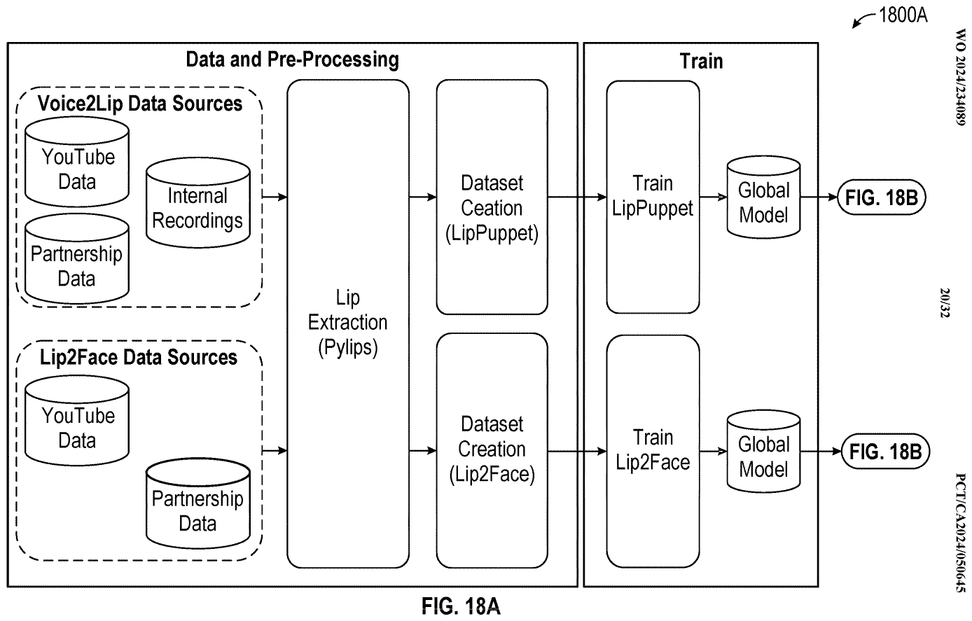

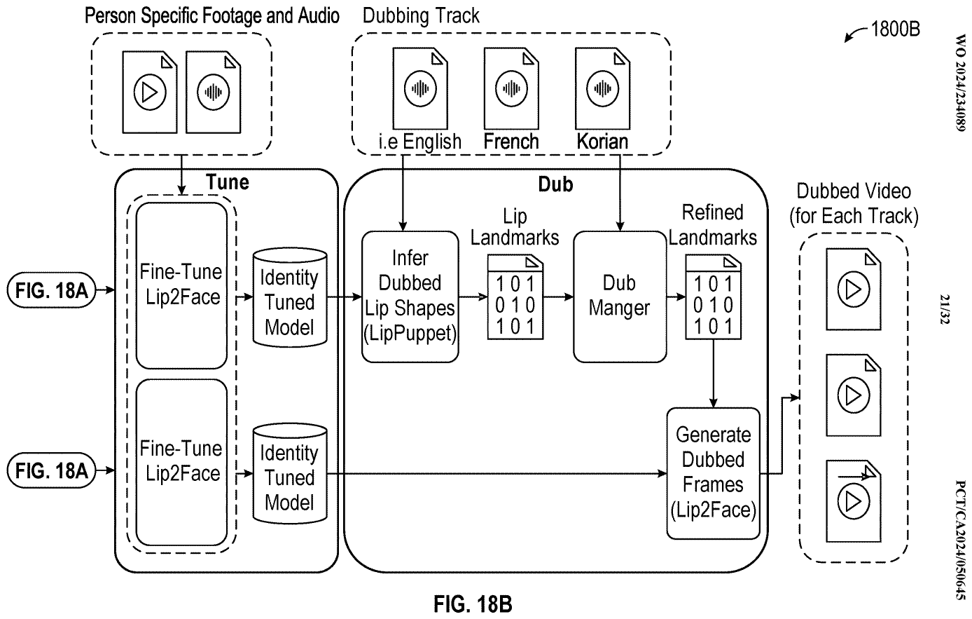

The process may be used in situations where frames cannot be simply copied from the input video V as explained in relation to FIG. 11. As depicted, the process may include a voice-to-lip step and lip to image step. As illustrated in FIG. 18, the process of lip dubbing as described may be performed using system 1800. System 1800 may be part of system 900 and may include a voice-to-lip network and a lip to image network. The voice-to-lip network may be a transformer neural network.

A transformer neural network is a neural network that learns context and thus meaning by tracking relationships in sequential data. The voice-to-lip network may be used to personalize the geometry (through fine tuning) of the lips according to the speaker. The voice-to-lip step may involve receiving the geometry of a lip and animating the lip according to a voice or audio signal.

The lip to image step may involve receiving the personalized geometry of the lips (according to audio) along with every frame that needs to be dubbed. As will be described in further detail below, each frame to be dubbed may first be analyzed to extract existing lip shape for the purpose of masking the lip and chin.

As will be described in further detail below, the lip to image step may then be tasked with “filling” this mask region corresponding to the given lip shapes. Masking is a critical step as without it the network fails to learn anything and simply copies from the input frame.

As shown in FIG. 12, there is a pre-training step 1202 and an inference step 1204.

During the pre-training step 1202, both of the voice-to-lips 1206 and the lips-to-image 1208 models are trained, for example, using identity or identity+shift pairs for various individuals, such that the model interconnections and weights thereof are refined over a set of training iterations. The training can be done for a set of different faces, depending on what is available in the training set.

During the inference step 1204, both of the voice-to-lips 1206 and the lips-to-image 1208 models can be fine-tuned for a particular individual prior to inference for that particular individual.

### Voice-to-Lip

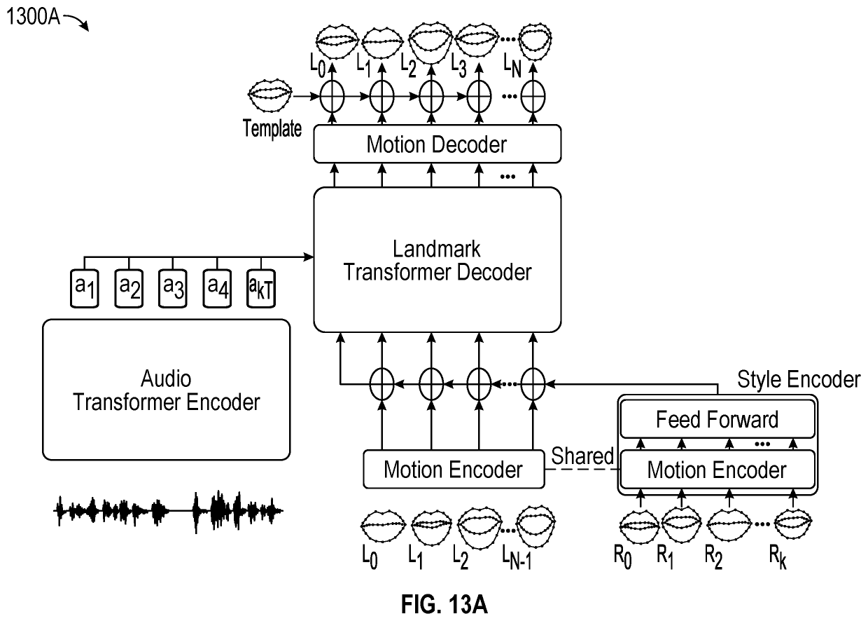

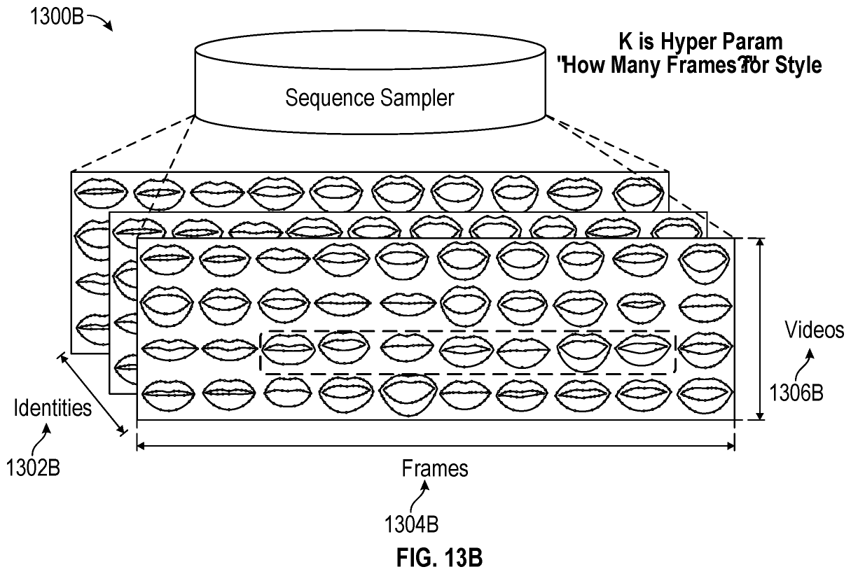

FIG. 13A shows an example voice-to-lip network 1300A, according to some embodiments. The voice-to-lip network may use a transformer-based architecture. The voice-to-lip network may be trained end to end to autoregressively synthesize lip (and chin) landmarks to match input audio. As illustrated, the transformer model may include a TransformerEncoder which encodes input audio into “tokens”, along with a TransformerDecoder which attends to the audio tokens and previous lip landmarks to synthesize lip landmark sequences. The transformer encoder matches Wav2Vec2.0 design and may be initialized with their pre-trained weights. Wav2Vec2.0 is a model for self-supervised learning of speech representation, the vector space created by the model contains rich representation of the phonemes being spoken in the given audio.

The Wav2Vec2.0 model is trained on 53,000 hours of audio (CC by 4.0 licensed data) making it a powerful speech encoder. In contrast to the model of FaceFormer, the present application focuses on explicit generation of lips (as opposed to full face) along with personalization of lips for new identities not in the training set. Faceformer is a transformer-based autoregressive model which encodes the long-term audio context and autoregressively predicts a sequence of animated 3D face meshes.

The voice-to-lip model aims to address three problems in prior approaches.

Restrictive data: The most common data sets in voice-to-lip models are BIWI and VOCASET datasets. These datasets consist of audio snippets of multiple identities along with an extremely high precision tracked mesh (i.e., 3D model of face) of the speaker. The problem this introduces is that it is impossible to fine tune the model due to the need of a similar quality mesh of the target identity.

Identity Templates: Additionally, since the BIWI and VOCASET dataset are created in a “clean” (read unrealistic) setting they can supply a template mesh of the identity from which predictions are made. Once again, this restricts the ability to fine-tune for a new identity as acquiring this mesh is not practical.

Lip Style: Finally, FaceFormer, learns the “style” of each speaker through an embedding layer that takes as input a one-hot embedding keyed by the identity of lips and voice in the training set. This choice restricts the model to predict lips according to one of the identities in the training set. Using the lips of another individual to make predictions may provide be problematic since the geometry of an individual's lip is unique.

As described herein, the voice-to-lip model may be trained to predict lip landmarks for an individual based on any video provided having image frames capturing the individual speaking. The benefit of processing videos directly, is that the landmarks extracted for training purposes can be extracted from any video, enabling fine tuning to target footage.

The voice-to-lip model is configured to extract lip landmarks, audio, and an identity template from a reference video corresponding to the individual. The reference video is labelled with the identity of the individual. An identity template may be a 3D mesh of an individual's lips. This data is then smoothed to reduce noise (remove high frequency noise) before being used for training. In some embodiments, the voice-to-lip model may extract 40 landmarks from the lips, along with 21 landmarks that describe the chin line, for a total of 61 landmarks. It should be understood that a different number of facial landmarks (e.g., lip landmarks) could be extracted.

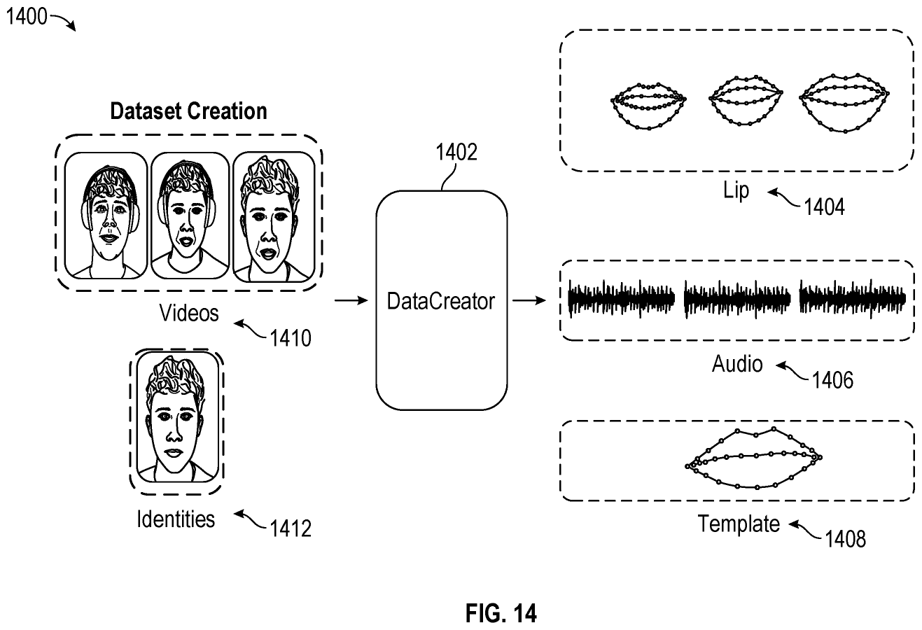

FIG. 14 is a block diagram 1400 showing a voice-to-lip model having a data creator model 1402 configured to extract lip landmarks 1404, audio 1406, and an identity template 1408 from a reference video 1410 corresponding to an individual identity 1412.

An identity template may be a 3D mesh of an individual's lips. The synthesized lip or chip landmark data sets tuned for the individual may be determined based on a deviation from a particular identity template 1408.

Identity templates 1408 may be extracted in multiple ways. For example, identity templates 1412 may be generated based on a “resting” pose image (labelled as “identities” in FIG. 14). This idea of a “resting” pose image closely follows BIWI and VOCASET datasets which provide a similar identity template mesh. However, this approach is limited since a “resting” post image may not be available for new identities. In the present invention, the identity template 1408 for an individual is generated from an average of all extracted landmarks from a reference video corresponding to the individual. Supplying a single identity, created from the average of all extracted lips not only performs better, but removes the problem of deciding which template to predict deltas from.

Finally, as lip style (personalization) is important for the generation process, the present approach attempts to remove the dependence on “one-hot” identity specification present in FaceFormer. Instead of “one-hot” identification which limits the model to generating lips according to styles of identities in the training set, the present invention attempts to learn speaker “style” from a given sequence of lips of the individual. For example, the model may sample a landmark sequence from another dataset example for the given identity. This landmark sequence could then be used to inform speaker style. The idea is that by swapping the sampled sequence for each sample (but ensuring it is from the same identity) the “style embedding” layer will be able to adapt to new identities at test time.

FIG. 138 shows an example sequence sampler 13008, according to some embodiments. The sequence sampler may include a plurality of mouth shapes based on identities 1302B, frames 13048, and videos 1306B.

The voice-to-lip model map be fine tuned for a new identity by extracting lip landmarks and voice from the original video and specifically tuning the “style encoder” for the new target identity. Once fine tuned, the voice-to-lip model can generate lips from arbitrary audio in the style of the target identity.

### Lips to Image Network

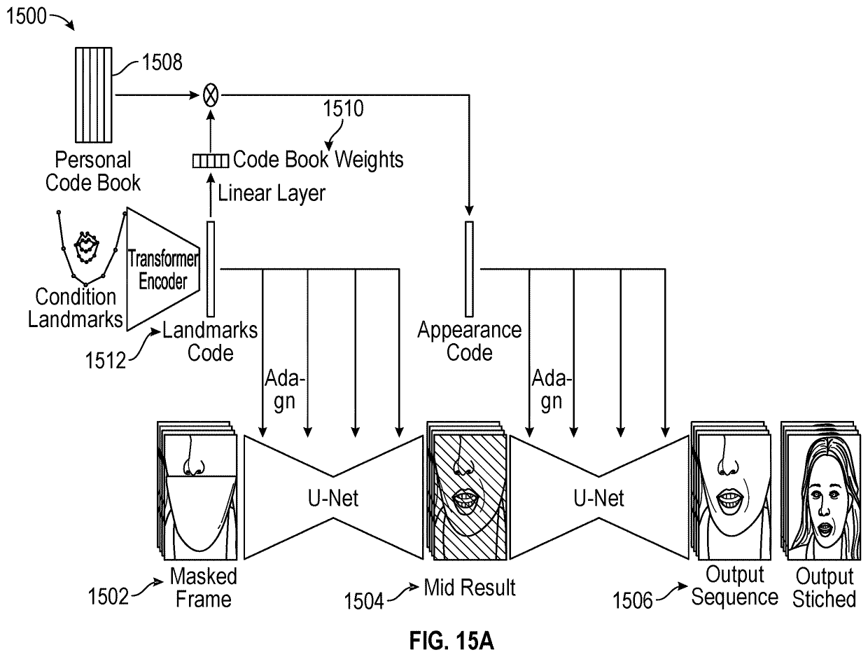

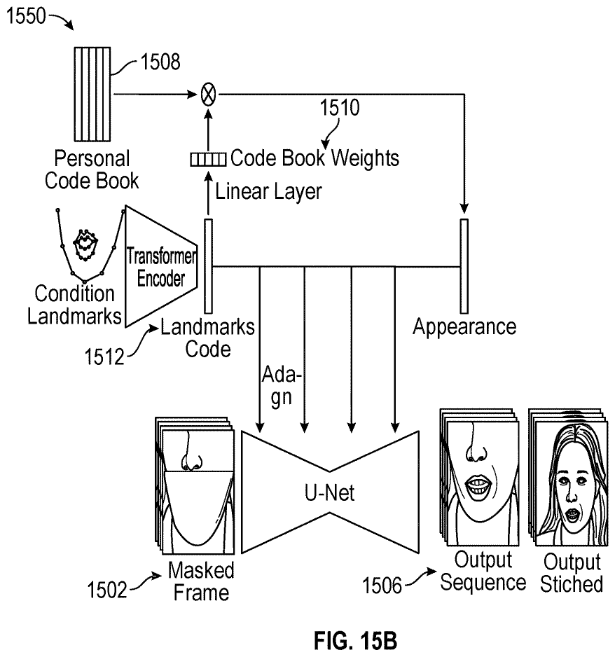

FIG. 15A is an example lip-to-image network 1500, according to some embodiments.

As depicted, the lip-to-image network 1500 includes a first stage and a second stage. In the first stage of the network, a masked frame 1502 and a landmarks code 1512 (see explanation below) that is learned from the lips and jaw geometry is received to produce a rough estimation or a mid result 1504 of the reconstructed frame. The reconstructed frame may miss certain details. In the second stage of the network, an appearance code and the mid result 1504 from the previous stage is received to produce a detailed reconstruction as an output sequence 1506. The detailed reconstruction may include details that were previously missed in the mid result 1504.

The lip-to-image network 1500 may include a transformer encoder to encode the lip geometry of the target lip and jaw landmarks. This encoding of the target geometry is referred to as the “landmark code” 1512. As depicted, the landmark code 1512 may be passed to both the personal codebook 1508 and the first stage of the network via adaptive group-wise normalization layers. Note that the appearance code may be learned according to the ID. To obtain the appearance code, a personalized code book 1508 may be learned for each identity. Then a set of coefficients or weights 1510 may be estimated according to the landmarks code that are multiplied into feature vectors of the codebook to produce the final appearance code.

For both stages, U-Net network with a similar structure to DDPM may be used.

In order to make the lip geometry and texture believable, the network 1500 may first be trained on an initial dataset of various speakers and later fine-tuned to target a video of a single actor speaking. This fine-tuning process biases the network 1500 into generating lip geometry and textures that are specific to the target actor being dubbed. Note that the personal codebook may be first learned on the whole dataset and then fine-tuned for an identity.

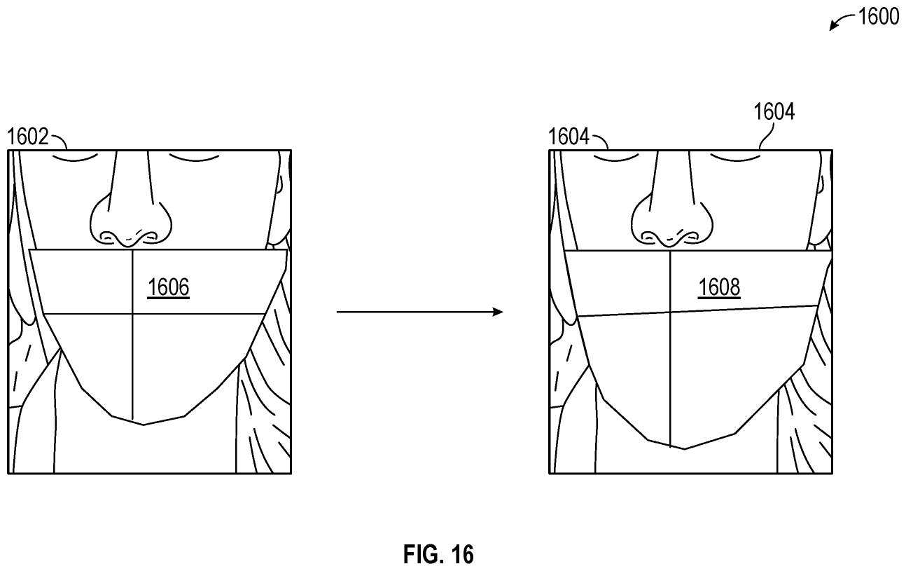

In some cases, the lips in the input frame may be sealed and the lips in the output frame may be opened. In some cases, the lips in the input frame are open and the lips in the output are closed. As shown in FIG. 16, a process 1600 is implemented by the system to address these situations, the input frame 1602 may be masked by a masking region 1606 according to the maximum area that the jaw covers to reduce potential texture artifacts in the detailed reconstructed frame 1604. The masked frame may define an in-painting area 1608 for generation of at least one of the rough reconstructed frame (i.e., mid result) and the detailed reconstructed frame. This is critical since otherwise, double chins or some artifacts in the texture may appear.

The lip-to-image network 1500 may utilizes various losses. A number of example losses are described below, for example, using a first, a second, a third loss, and/or a fourth loss that can be used together in various combinations to establish an overall loss function for optimization.

The first loss may be a mean squared error loss for measuring the squared difference in pixel values between the ground truth and output image of the network 1500. The second loss may be a Learned Perceptual Image Patch Similarity (LPIPS) loss that measures the difference between patches in the ground truth image versus the output image of the network 1500. The third loss may be a “height-width” loss which measures the difference between openness of the lips between ground truth and network output. The neural network may be used as a differentiable module to detect landmarks on the lips of the output as well as the ground truth and compare the differences in lip landmarks (i.e., fourth loss). Lastly, a lip sync expert discriminator to correct the synchronization between the audio and the output.

The lip-to-image network works directly on a generator network, such as but not limited to StyleGAN. The approach learn a set of codes that represent visemes and then according to each lip shape, the network produces a set of coefficient that if multiplied into the codes, any lip shape is produced.

This expressiveness is such that for a given point in the latent space representing a face, moving along a certain direction results in local, meaningful edits of the face. E.g., moving in one direction might make a black hair blonde, and moving in another direction might change the lips to smiling.

The problem that the approach aims to solve is finding directions in the generator (e.g., StyleGAN) latent space that represent different lip movements of a person while talking. Applicant approaches this problem by realizing that human lip movements can roughly be categorized in a limited number of groups that, if learned, can be combined to create any arbitrary lip shape.

In some embodiments, a system may include a machine learning architecture that has just a single U-Net network. FIG. 158 is another example lip-to-image network 1550, according to some embodiments.

As depicted, the lip-to-image network 1550 includes just a single U-Net network. A masked frame 1502, a landmarks code 1512 learned from the lips and jaw geometry, and optionally, an appearance code are received and processed by the U-Net network model to produce the final reconstructed frame 1506, skipping the mid-results in FIG. 15A. In some embodiments, the appearance code is not used to generate the output sequence 1506.

The lip-to-image network 1550 may include a transformer encoder to encode the lip geometry of the target lip and jaw landmarks. This encoding of the target geometry is referred to as the “landmark code” 1512. As depicted, the landmark code 1512 may be passed to both the personal codebook 1508 and the network via adaptive group-wise normalization layers. Note that the appearance code may be learned according to the ID. To obtain the appearance code, a personalized code book 1508 may be learned for each identity. Then a set of coefficients or weights 1510 may be estimated according to the landmarks code that are multiplied into feature vectors of the codebook to produce the final appearance code.

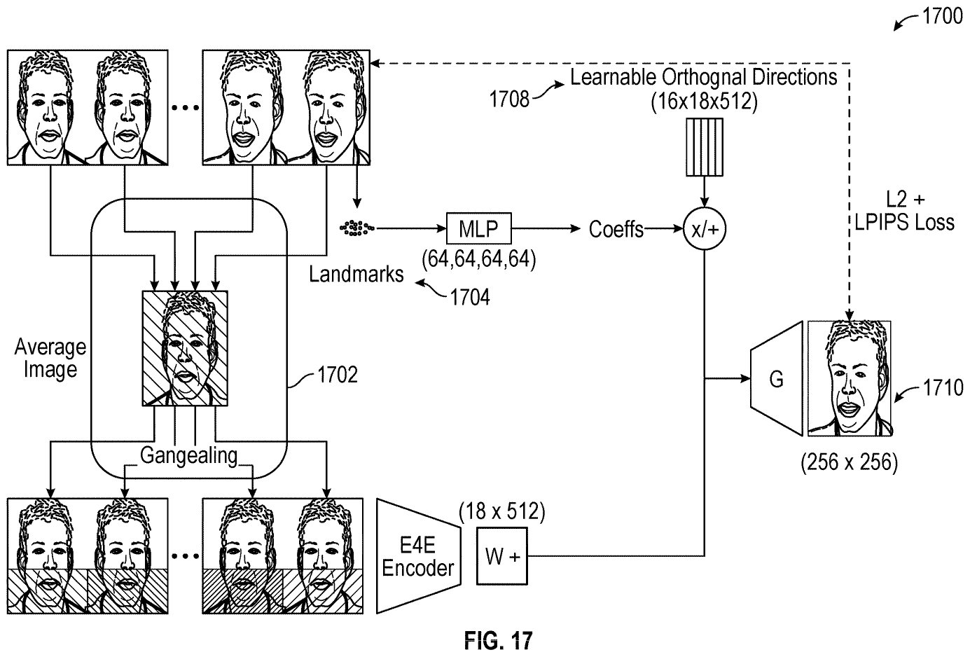

FIG. 17 shows an example architecture 1700 of a model, showing a number of steps for face generation.

In the first step, the system changes the lip shapes of each frame of the given video to a canonical lip shape and encodes the image to the StyleGAN latent space using E4E. The canonicalization of the lip shapes can be done in several ways. One method is to mask the lower region of the face similar to the U-Net approach and train an encoder from scratch to learn the canonical lip shapes. Another approach is to apply Gangealing process 1702 to every frame, take the average of the frames in the congealed space and paste the lower part of the average image back into every frame. The benefits of this method compared to the masking method are that one can avoid training the encoder from scratch by using a pretrained E4E encoder, and the details of the lower face region would not be missed due to masking.

In the second step, the system is adapted to learn the editing direction, which changes the canonical lip shape to an arbitrary lip shape represented by a set of lip landmarks 1704. This is done by representing different lip movements with a linear combination of a set of learnable orthogonal directions 1708 in the StyleGAN space. Each of these directions should represent a change from the canonical lip shape to a viseme, and a combination of these visemes can be used to generate any arbitrary lip shape. Applicant frames the problem of learning these directions as a reconstruction problem where the network directly optimizes the directions by learning to change the canonical lip shape of each frame to the correct lip shape during training.

More precisely, Applicant first extracts the landmarks 1704 from the face in a given frame and pass it through an MLP to determine the coefficients of the linear combination. Then, the system orthogonalizes the directions using the Gram-Schmidt method and compute the linear combination. Finally, the system add the combination to the canonical latent code given by the E4E encoder.

In the final step, the system passes the resulting latent code from the previous step, to the pretrained StyleGAN generator and output an image 1710. The training process is supervised by L₂ and LPIPS loss between the output of the generator and the given frame.

For performing lip dubbing on a given video, instead of extracting the lip landmarks from the frames, in this embodiment, the system can get the stream of lip landmarks from the Voice2Lip network and pass them into the framework.

Voice2Lip was an auto-regressive model conditioned on audio to produce “lip vectors” that when passed to Lip2Face correspond to the correct mouth shape on generation. Simplifying the auto-regressive model to simply one-shot produce vectors in a given window is not only faster but produced more stable and realistic vector sequences. The faster training explores variations on architecture faster with fewer resources, which leads to finding a configuration that produces articulation results far better than seen previously.

FIG. 18A and FIG. 18B are a process flow diagram (including sub-process 1800A and sub-process 1800B) mapped across two pages that show an approach for utilizing the machine learning approach for generating output video, according to some embodiments.

In FIG. 18A, a process 1800A is shown to illustrate how training and fine tune the autoregressive model for inferring lip shapes from audio.

### Initial LipFormer Flow and Method Steps

The sub-process 1800A starts with training data, and in this approach, an example is described in relation to a system for forming lips (e.g., LipFormer). The training data for LipFormer can be video recordings in which there is a single speaker in view, speaking into the camera. This data can be collected by recording internal employees speaking predefined sentences that target a range of visemes (lip shapes).

Once this data is collected, the system can start the lip former pre-processing process. For each video in the data set the flow can include:
1. Detect face and landmarks for each frame in video
2. Project 2D pixel space landmarks to canonical 3D using Procrustes analysis
   a. Canonical representation moves all landmarks to common space, unaffected by position of face in image
3. Extract audio from video
4. Write audio, landmarks, and identity to dataset for training
   a. Identity is tagged on videos for simplicity

A machine learning model, LipPuppet, is trained to generate lip landmarks, given only audio and an identity. The system can train LipPuppet on a “global” data pool, and then in sub-process 1800B, fine tune the model on any new identities. Without fine-tuning, the global model can produce lip shapes that match any of the training identities, but will not capture the details of a specific unseen identity.

LipPuppet can be used directly without finetuning, but the lips will not capture intricacies of each unique identity. If data is available for fine tuning, LipPuppet can be tuned to the identity of interest using the following flow.
1. Process given identity footage according to “Data and Preprocessing”
2. Load global LipPuppet model
3. Initialize “style” embedding to be learnt
4. Optimize “style” embedding layer, freezing (or not) other LipPuppet layers
5. Fine tune to training data until converged

The goal of fine tuning is to learn the “style” of an arbitrary speaker that was not within the training set.

Once fine tuned, the inference flow can include:
1. Load identity specific (or global) LipPuppet model
2. Chunk audio segment into segments of length N ms (LipPuppet has a max sequence length)
3. Overlap audio segments by K ms
4. Forward pass on each segment
5. Concatenate generated lip landmarks, averaging in regions of overlap

The lip landmarks can now be used for Lip2Face. Note that not discussed here is the “Dub Manager”, which can be configured to apply filtering on the lip landmarks before passing to Lip2Face. This filtering is to help with transitions between silences in dubbing tracks and moments in which the lip shapes match between source and dubbing.

Initial Lip2Face flow and method steps are described in relation to how the system trains and fine tune the model for infilling lip texture given a lip shape and masked input frame. Lip2Face data requirements are similar to LipFormer except that no audio is required. Lip2Face may require original frames along with their extracted landmarks.
1. Detect face and 2D landmarks for each frame in video
2. Crop and rotate image to the face
   a. Rotation keeps eyes in common locations
3. Generate mask that obscures the mouth region
   a. Can be from nose tip down, or a contour along the chin
   b. Can also include the nose region, and extending to cover the mouth region
4. Write out images, crops, masks, and landmarks

In some embodiments, masking from nose tip down (i.e., excluding nose) can enable information smuggling during training, causing the machine learning model to over-attend to laugh lines or cheeks in the input frames. Therefore, maskings that include additional region, such as a masking that includes the nose region, may bring technical and drastic improvement to the results.

The presence of certain facial expressions, such as laugh lines, limits the flexibility of the machine learning model in positioning the lips on the face. This is because the laugh lines are also taken into account (i.e., interpolated) when generating new lip shapes suggested by the neural network of the machine learning model. As a result, the network needs to, during training, balance both the desired lip shape (suggested by the lip geometry condition) and the constraints imposed by the laugh lines present in the input video.

For example, a person in an input video may have laugh lines. In reality, one person cannot make an “ooo” mouth shape while also having laugh lines. During training, the machine learning model may inadvertently receive hints on lip shape from information hidden in laugh lines, leading to information smuggling. This can cause the model to over-focus on laugh lines or cheeks during inference, leading to inaccurate lip shape predictions. Therefore, masking one or more regions of a face that have high correlation to the lip shape leads to improved machine learning model performance.

In some embodiment, input images are only used for texture, while the lip landmarks are only used for mouth shape.

Lip2Face is trained to “in fill” a given masked input image using given lip landmarks for that frame and, optionally, an identity. The system trains Lip2Face on a “global” data pool, then can fine tune it on specific identities to capture better textures. In another embodiment, the model could be used without finetuning, but if data is available, fine tuning will improve the results.

### Fine Tuning

As noted above, Lip2Face can be used directly without fine tuning but the textures of generated lips may not be high quality. If data is available, Lip2Face can be fine tuned using the following flow.
1. Process given identity footage according to “Data and Preprocessing”
2. Load global Lip2Face model
3. Initialize “style” embedding
4. Optimize “style” embedding, freezing other Lip2Face layers (or not)
5. Fine tune to training data until converged
   The goal of fine tuning Lip2Face is to learn a “style” embedding that represents this new unseen identity.

The inference process for Lip2Face can use landmarks generated by LipPuppet. Lip2Face can also use landmarks extracted directly from video footage, which simplifies the flow. The following process is used to create new dubbed frames from lip landmarks.
1. Process video to be dubbed according to “Data and Preprocessing”
2. Load driving lip landmarks generated by LipPuppet
3. Align driving landmarks to extracted “source” lips using source lip transform from pixel to canonical space
4. (Optional) Least squares lip personalization of lip landmarks to match source
   a. Can be used if LipPuppet fine tuning was not performed or was not successful
5. Forward pass on each masked source frame, replacing landmarks with the loaded and aligned driving landmarks
6. Create video from inference results adding dubbing audio as the track.

At the end of this process, an output is dubbed videos. A “Dub Manager” process can be used again here, to replace frames that are not required (for example, when there is character laughing, or dub and original being silent, these frames can be removed).

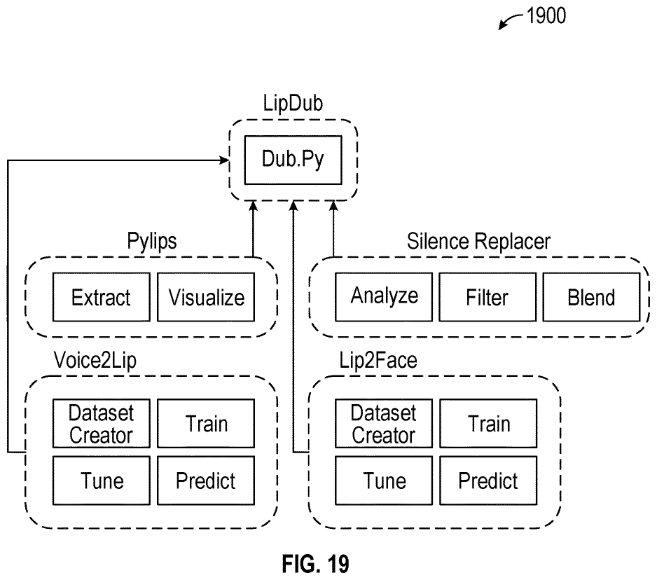

FIG. 19 is an example block schematic diagram 1900 of components of a system for conducting lip dubbing, according to some examples. In block schematic diagram 1900, a set of computational processes are shown including different machine learning models and programmatic code execution blocks that can be implemented in the form of a modular computer program stored on non-transitory computer readable memories.

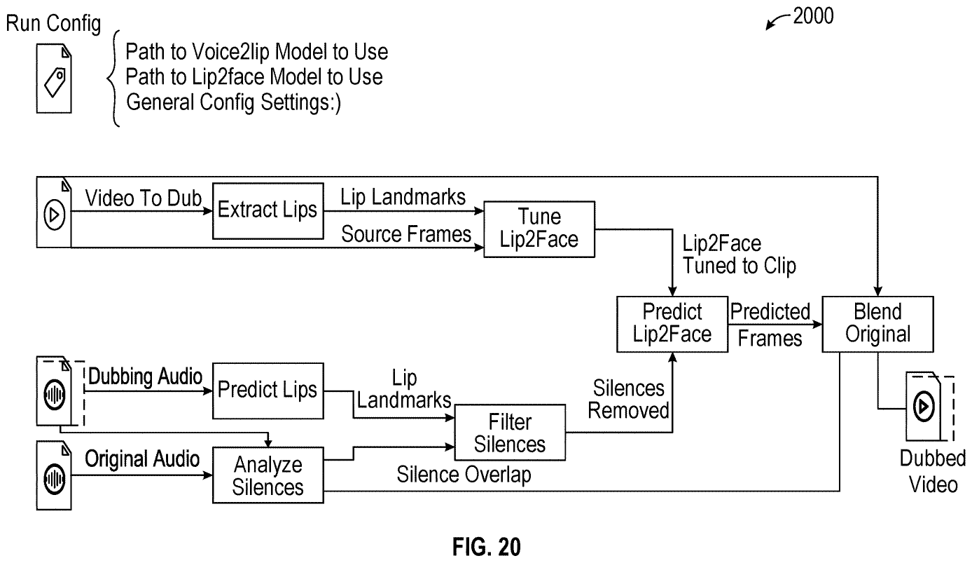

FIG. 20 shows an example computational process flow 2000 that can be used in a commercial practical implementation as part of a processing pipeline. In FIG. 20, the diagram shows steps that can be conducted in parallel and serially such that computational inputs are received, models are trained, and the trained models are deployed to automatically generate outputs in accordance with various embodiments described herein.

When generating video with mouth features replaced to correspond with new audio tracks (e.g., desired audio) or new audio instructions (e.g., desired text), there are some limitations that can arise when using a landmark based approach, where a first model is used to infill a masked frame according to given lip landmarks (e.g., a Lip2Face model that conditions a U-Net on lip landmarks), and a second model is used to generate landmark sequences from audio (LipPuppet), where each component is trained independently then combined for inference. Using landmarks, tongue and teeth position may not be captured, and detection might not be perfect, so that errors in direction may result in noise.

Facial landmarks are also specific to a specific person, and accordingly, there can be, at test time, a domain shift when generating landmarks from audio. During training, the landmarks are given as a driving condition to match the identity of the crop the system is infilling, and during test, an audio to landmark model generates landmarks from audio as driving condition. Domain shift comes from the fact that generated landmarks are generated from some “other” identity. In particular, the domain shift can result in unrealistic mouth shapes and sometimes textures is geometry is too far from source identities geometry. Far, as a term, refers to extracted landmarks that are canonicalized by removing pose/scaling, and then normalized to center the eyes in a common location. However, the distance of mouth from chin and shape of chin for example, can not be easily removed, and these local geometric details are unique per person and result in errors.

Additionally, given the network's dependence on accurate landmark positioning during training, any noise or error in landmark detection or generation can introduce visual jitter in the form of lip quivering or shifting.

Accordingly, an alternate variation is proposed below that is adapted to overcome some of the limitations of the landmark based approach.

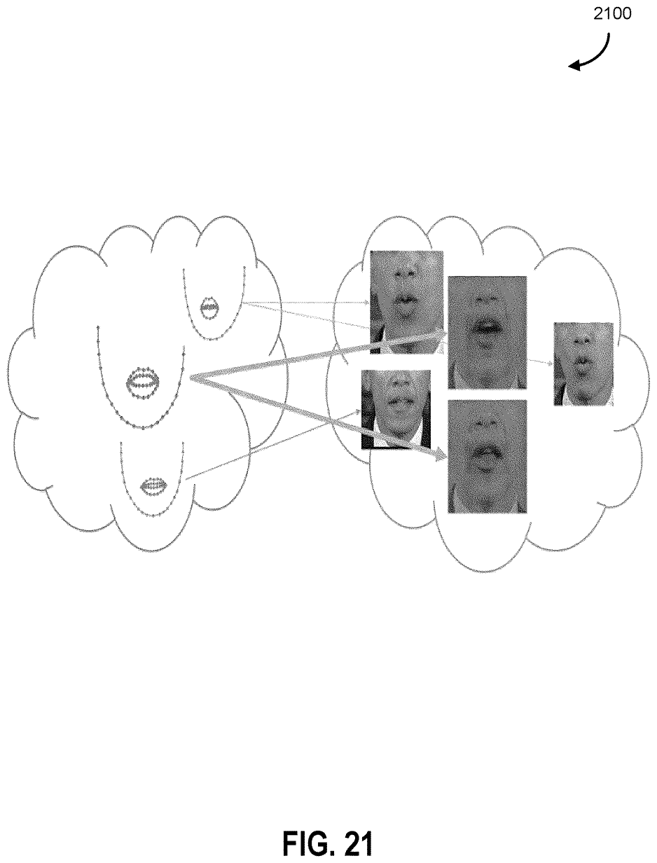

FIG. 21 is a diagram showing issues with blurred mouth internals. As depicted in examples 2100 in FIG. 21, landmark (geometry) gives information only on the mouth shape not the mouth internals (tongue position and teeth) as a single mouth shape can have multiple tongue and teeth positions, and accordingly, the landmark representation can potentially introduce ambiguity.

The main reason for each ambiguity is the one to many nature of the landmarks to the internal mouth as depicted below. This way, the network is not able to consistently find a mapping between the lip shape and the correct internal mouth. Given that landmarks simply do not contain information on the tongue and teeth positions, there is no way for the network to learn this mapping.

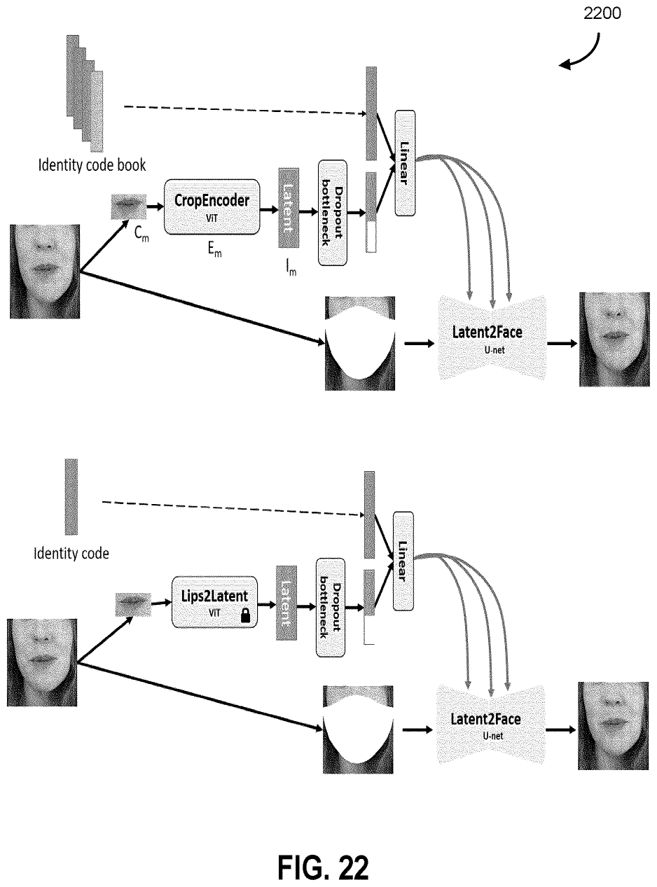

FIG. 22 is shows an example architecture 2200 adapted to improve issues relating to mouth internal generation, according to some embodiments.

The limitations that arise include: ambiguity on tongue and teeth position when conditioned on landmarks resulting in blurry internal mouth textures, visual jitter in the form of mouth shifting or lip quivering in the result due to landmark detection error, and finally a domain shift due to identity specific geometry details in train that cannot be captured from audio. For example, it may be difficult for the model to generate the mouth internals, such as the positioning, shape and orientation of teeth, tongue from landmarks.

The generation process can also inadvertently introduce artifacts, that arise, for example, because landmarks generated by LipPuppet must match the target identity's geometry, and while Lip2Face is trained on lip landmarks matching the target identity, then in test time, the generated geometry does not match due to a domain shift (e.g., resulting in a too open/too closed/pursed lips in a generated dub or in extreme shifts, complete failure to generate realistic textures).

To overcome the “internal mouth ambiguity” problem, a novel approach is proposed by Applicant, instead of having a U-Net condition generated from landmarks, a U-Net generated from a mouth crop is used instead. A U-Net is a convolutional neural network developed for image segmentation. A U-Net architecture is a symmetric architecture with two major parts, a contracting path portion, and an expansive path portion, and is used to learn segmentation in an end-to-end setting. The U-Net architecture has a U-shaped architecture, The contracting path can include a convolutional network that consists of repeated application of convolutions, each followed by rectified linear units (ReLu) and a max pooling operation, for example. On the other hand, the expansive pathway can combine feature and special information, and can include up-convolutions and concatenations from the contracting path. There are variations of U-Net architectures.

The U-Net architecture is designed to take as input a masked crop of a person's face, along with a guiding condition specifying lip shape to “render” in the mask region. An example guiding condition could be a driving condition such as latent code lₘ. A U-Net was selected for use over a purely generative model as it allows one to pass in the crop of the face. Giving a face crop as input allows the network to learn per frame lighting, pose, and skin detail from the unmasked reasons. For example, seeing the angle of nose, shadows on face, and texture of skin all give information to the network on how to infill the masked region. If one were to give the entire crop without masking then the network would simply learn to copy pixels of the mouth over to output and ignore the driving condition entirely. Masking ensures that the network has an objective and remove paths for it to “cheat”.

A mask is a binary image matching shape of the input crop that can be applied to the input crop by multiplying them together. The resulting image is one in which any index (i.e., pixel) in the mask that was 0 now scales the RGB pixel result of input crop to 0, while any index in the mask with value 1 keeps the original RGB value.

How the mask is created is a pertinent consideration. The more of the face crop that is obscured on input, the less frame specific information the network receives, and the harder the model is to train. For example, if the entire background is masked, the network must learn to reconstruct it along with the viseme. As the background is not related to the viseme, this ambiguity results in difficulty converging during training. Further, any time dependent effects such as pose change, flashing lights, occlusions, cannot be reconstructed if masking is too extreme on frames.

On the other hand, masking too little can result in information leakage allowing the network to infer mouth shape from the input crop instead of the driving condition, and this is a specific technical objective that the technical design needs to be adapted for. When this occurs, there can be observed strong reconstruction of source lip shapes, but a loss in the ability to modify the lip shape to a new target. In other words, the model has over-fit to reconstruct the source frames. Through experimentation, Applicant has found that it is useful to mask any visible cues in skin that relate to the mouth shape being created. For example, opening the mouth can cause laugh lines to crease more deeply. If laugh lines are not sufficiently masked during training the network learns to rely on their presence to inform mouth shapes. The proposed approach is useful to reduce this overfitting by utilizing a specific masking approach (e.g., to avoid the influence/bias from visible cues in skin). The specific mask being used can be specifically adapted to mask certain frame information, such as visible cues in skin, parts of a person's face, among others, which helps improve the performance and accuracy of the network.

A specific binary mask approach is proposed below, which is an example proposed approach that is useful in providing a balance between over and under masking.

The binary mask in the proposed approach is created from landmarks extracted from the input crop. Landmarks correspond to semantic locations of the face such as nose tip, left eye iris, left of mouth etc. These landmarks can be provided in the form of coordinates or pixel identifiers.

The system initializes the mask to ones, for example, according to the shape of input crop. Then, a convex hull can be created, formed from the extracted landmarks from the tip of left ear, along the chin to right ear tip, then across to the mid point of nose tip and eyes, finally ending back at the left ear tip. The segment of mask from right ear tip to mid point of nose to right ear tip is created as smooth spline to ensure the laugh lines are within the masked region. The convex hull thus covers the area of the mask. For illustration, a convex hull may be represented in the form of a polygon or other shape which encompasses a set of points in Cartesian or Euclidean space, such that a mask can be formed from the area within the convex hull. A simple example of convex hull can be a bounding box, for example, but the variations described herein are more complex, as described above, where specific facial landmark data objects can be used to establish a complex shape with improved mapping to the person's face.

Effectively, a convex hull can be a set of points as defined by a data object that is generated in relation to specific images. It can be a bounded set of points in the area. From a data structure perspective, the mask can be a binary mask (e.g., 0's and 1's to represent masked or not masked areas), but other variations are possible. For example, instead of a binary mask, a gradient mask can be applied with specific weightings for individual pixels within the convex hull. In a gradient mask, the weightings can vary from 0-1, and these can be used as multipliers to modify influence, for example, and this can be used, for example, to have a varying effect as the mask approaches mask boundaries (e.g., lower weightings for edges of the hull).

Noise can then be applied to this mask in the form of translation/rotation/perspective transform/and vertex jitter (e.g., Gaussian noise) to build robustness to landmark detection. Without augmentation to the mask (via noise), there can be artifacts such as jitter in output textures. Jitter can be removed by smoothing. The application of noise effectively adds a technical improvement to provide different variations or to add a level of randomness to avoid the system overfitting to the mask or overfitting a mask.

Landmarks are used to create crops to the face, generate the masks to be applied to the crops, and optionally as a driving condition to U-Net model. Landmark detection is not guaranteed to be temporally consistent from one frame to the next, even when subsequent frames are extremely similar. When visualized this temporal inconsistency can be seen as jitter or noise in detection.

Additionally, when used directly in inference this jitter can also be reflected in the output of the model where lips shift and move slightly from frame to frame in unrealistic ways. To mitigate this problem, an approach can include apply temporal smoothing to all extracted landmarks. Temporal smoothing consists of a moving average or low pass filter to remove high frequency noise from landmark detections. When smoothed appropriately, the system can remove jitter artifacts from results making for much more realistic lip motions when frames are viewed sequentially.

In one embodiment, the approach includes giving as input to the U-Net model an additional rendering of the extracted landmarks for implicit information of the face pose. This rendering is generated by extracting landmarks from the face, creating a mesh of the landmarks, and coloring pixels according to either the normals of each triangle or the index of each triangle. The render can then be concatenated in channel dimension before being passed to the U-Net. Applicant finds experimentally that supplying this render as input can reduce an artifact known as “texture sticking” where as the characters pose changes, certain (typically high frequency) textures stay locked to the pixel location instead of following the characters' motion. For example, a characters stubble or pores may appear to slide across their face as their pose changes. Supplying a render as input has minimal computational overhead due to the convolutional U-Net architecture. The proposed approach (supplying the additional render) aids in avoiding the practical issue as described above where certain visual effects become stuck. This can avoid the stubble or pores to be stuck following motion, and can be useful in practical usage scenarios especially in higher definition video where pores, facial hair, etc., are more readily visible. This is important for feature productions that are being shown in large screen formats, such as for movies shown in movie theatres, etc., where the stuck motion could be a distraction for the audience as an additional point that could lead to uncanny valley effects.

Coloring of the mesh in render can be done using the normals of each triangle, normals of each vertex, index of face in mesh, or using a positional encoding. In the case of positional encoding, the approach can treat each face as a unique id and generate a code per id. If the mesh has 500 faces, the approach generates 500 codes. Where standard rendering produces an RGB image of 3 channels, rendering with these codes produces an image with depth equal to the length of any single code. This extended depth gives the network more explicit differentiation between the positions of each pixel with respect to the person's face. Note that these codes can be static during training or updated as a parameter of the training process.

The architecture in this embodiment based on a representation that is known to contain mouth internal information, a crop of the mouth. With this focus, a number of components of the improved architecture are described:
(1) An image encoder Eₘ that receives a mouth crop Cₘ and produces a latent code lₘ that can be used as the driving condition for the conditional U-Net;
(2) An identity code book for promoting identity disentanglement in latent codes lₘ;
(3) A dropout approach for to encourage compact, hierarchical latent code; and
(4) VectorPuppet, an auto regressive model to generate latent code lₘ from audio.

All or some of these components are utilized in various embodiments.

Depending on the availability of training data, different steps can be taken. For example, if the system were to train on enough data of a single identity, it could be adapted to not require the identity code book. The image encoder resolves mouth internals, and the vector puppet is required to take advantage of this solution. The dropout approach can be required to allow vector puppet to train on compressed representation.

The identity code book is required to support applications where N minutes of footage are not available. It also reduces training time even when data is available.

The mouth encoder can replace or be used in place of the previous landmark encoder. In particular, where the U-Net was previously conditioned on a vector produced through a multi-layer perceptron (or similar) with landmarks as input, the U-Net can now be conditioned on a vector produced through a convolutional network (or more specifically a vision transformer) encoding an input mouth crop.

Where before LipPuppet was trained to output landmarks in sync with audio, the new “VectorPuppet”, which has the same or a similar underlying transform architecture, is trained to output mouth crop embeddings matching audio. In other words, the transformer architecture is trained to generate vectors from audio that when passed through the conditional U-Net create images of the mouth that match audio.

As a technical improvement, Applicant has found that the textures and lip shapes are have improved relative to the earlier approach. It is hypothesized that the landmark based design introduced an information bottleneck due to landmarks missing mouth internals. This bottleneck resulted in blurry textures and poor lip articulation. The problem of domain shift due to identity change can be drastically reduced by the usage of an identity code book with nested dropout, as described in embodiments below. Nested dropout in combination with the code book isolates identity from viseme, enabling user flows such as recording a video of themselves to be used as a driving condition.

By redesigning with crop encoder, the information bottleneck is removed, providing a practical technical approach for resolving tongue and teeth ambiguity allowing much higher quality outputs. This redesign also circumvents certain errors (i.e., noise in training) in the extracted landmarks.

The mouth encoder can replace the previous landmark encoder, and is designed to yield a vector describing the viseme of a given mouth crop to be used as the driving condition of the U-Net.

The mouth encoder, Eₘ, receives a mouth crop Cₘ and produces a latent code lₘ. If this latent code were to be passed directly to the unet as the driving condition, then there is no guarantee that it represents only the desired viseme.

Instead, as the model trains, one would note that the crop encoder yields an entangled representation containing pose/lighting/and identity of the given crop. This is problematic as a goal is to generate these driving conditions from audio. If the representation contains pose and lighting, then that information must also be inferred from audio, which is not possible.

A solution to this technical problem is proposed as there is no way to remove all identity/pose/lighting information from the input mouth crops. However, a non-trivial, innovative and unexpected approach is to instead make it difficult for the model to rely on the mouth crop, and importantly, the approach supplies the required information in other ways. By doing so, the network will learn to use other “more reliable” streams of information.

More concretely, Applicant proposes introducing a learnable identity code book and promote its usage with nested dropout on the latent code lₘ. The identity code book is a learnable N×K matrix where N is the number of identities in training set, and K is the dimensionality of each code.

During training, the system extracts the code from the identity code book according to the identity of example frame (known beforehand). This code serves as a unique representation of the identity being reconstructed. As these codes are learnable, on the backward pass, this code is updated.

The final condition given to the U-Net is a concatenation of the identity code and mouth crop latent code.

In a variant embodiment, the system passes this concatenated code through a dense layer to resize (i.e., 256+256→Dense Layer→256). Dense layer resizing allows larger independent vectors per feature (i.e. identity, mouth crop code, pose) then is expected by the U-Net. This property improves and simplifies design as pooling operations in U-Net restrict condition vector dimensionality to specific divisible values. The optional dense layer resolves an issue relating to divisible values by learning to compress vectors according to optimization, as opposed to simply guessing values for usage.

Another proposed approach to mitigate texture sliding is to give explicit pose information via a transform matrix concatenated to the U-Net condition. The input frame landmarks can be analyzed to extract pose information giving rotation and translation of the face within the frame. The rotation matrix gives explicit information on orientation (yaw/pitch/roll) of the head in frame and can be flattened from its base 3×3 form to a length 9 vector. This vector is then concatenated to the existing U-Net condition formed by identity and mouth encoding (whether from landmarks or mouth crop). Given that the U-Net requires a condition vector of size divisible by the number of pooling layers, when using rotation as input a linear layer can be used to learn a mapping from concatenated feature vectors (identity+viseme vector+rotation) to desired input latent code of U-Net (i.e., 512 or 256 or 64).

Another component of the proposed new vector2face architecture is the incorporation of nested dropout-based approaches.

Applying dropout to the latent code promotes the network to encode only essential information in the codes produced by crop encoder. In this case, essential information is the viseme as pose, lighting, and identity come from other sources.

Nested dropout is a variant of dropout which applies masking according to some predetermined importance.

The system is configured to apply nested dropout to mouth crop latent codes by randomly generating an index i that is smaller than the code length and zeroing out all the entries with index larger than i.

This way, since smaller indices in the code are more present in training, they attain more important information (likely visemes) and entries with higher index captures nuances and small scale details such as textures. The approach essentially create an importance ordered code where early indices contain the most pertinent information to generation.

Note that a goal is to produce the right lips from the audio. In the approach described earlier in this application, LipPuppet was trained to output landmarks matching the input audio. Since the proposed approach to improve the mouth crop encoder as described in the embodiments of this section changed the condition of the U-Net from landmarks to the encoding of the mouth crop, one needs to be able to produce these mouth crop encodings from the audio.

The new “VectorPuppet” architecture is proposed which has the same underlying auto-regressive transformer architecture as LipPuppet, but is trained to output mouth crop embeddings matching the audio. This approach creates a training dataset from videos by extracting audio along with mouth crop embeddings for each frame.

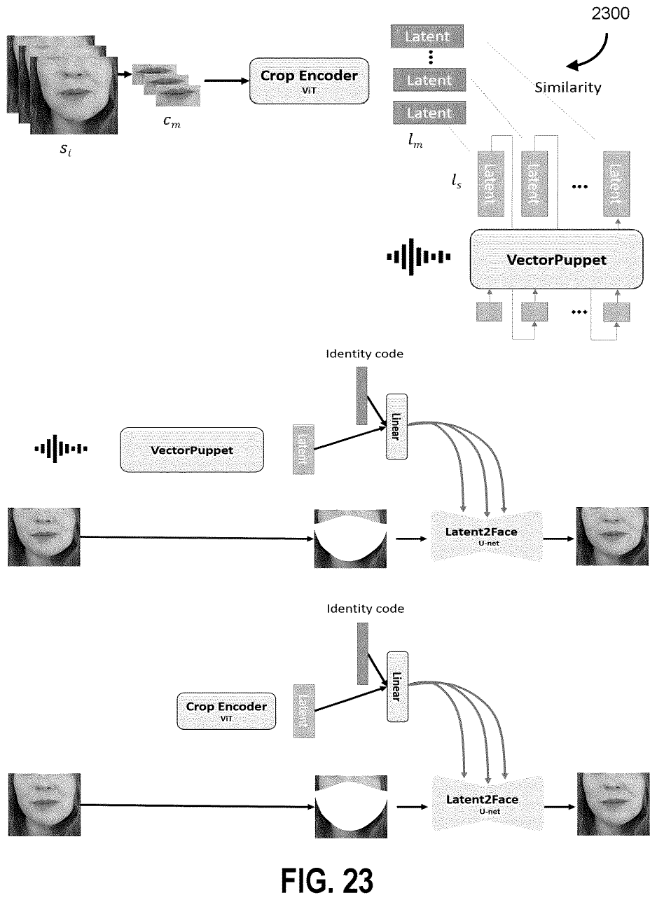

It is important to note that vector 2 face model training (see FIG. 22) must occur before vector puppet training as the approach generates mouth latent codes (lₘ) from the trained encoder. In this proposed approach, the system trains VectorPuppet to produce vectors lₛ from audio that match the frame extracted vectors lₘ. To enforce such similarity, one embodiment is proposed to use an L₂ loss between lₛ and lₘ. Another embodiment employs a latent code discriminator to learn space of real lₘ vs generated lₛ. FIG. 23 is an example diagram showing the VectorPuppet architecture being used in conjunction with the crop encoder architecture, according to some embodiments. FIG. 23 shows the L₂ loss between lₛ and lₘ. These embodiments are optional variants as Applicant has found that these approaches work well, but it is contemplated that other similarity measures between vectors could potentially operate well.

Relative to the alternate LipPuppet approach, generation quality has improved as textures and lip shapes are better. This is the main improvement to this design change. The landmark based design introduced an information bottleneck due to landmarks missing mouth internals. These bottlenecks resulted in blurry textures. By redesigning with the mouth crop encoder, the bottleneck is removed along with the ambiguity allowing much higher quality outputs. This redesign also circumvents error (i.e., noise in training) in the extracted landmarks.

Similarly, from a user control perspective, both landmark and mouth crop have the ability to intuitively influence output. The mouth crop encoder provides nicer abstractions for user. Where before the artist was able to modify landmarks in 3D space and see the effect on output (i.e., open mouth, move mouth), the artist can now make changes in mouth crop vector space. The crop vector space allow arithmetic operations between embeddings for interpolation. Given the vector space representation, a user could interpolate between two mouth shapes smoothly similar to blend shapes in 3D space. For example a performance could be “exaggerated” by interpolating the vector of a slightly open mouth to one that is more open). More importantly, the output of vector puppet can at any time be replaced by the embedding of a given crop image. This allows interfaces where the user might be able to “drop” an image of target mouth shape into view to change the output to be more like target mouth. Or, in another variation, the person could, record themselves lip syncing to content to edit the performance. In another variation, one could record the dubbing voice actors to “smooth”/replace the generated vectors from audio with vectors extracted from frames. Interpolation can occur, for example, by giving the model an image with a closed mouth and an image open mouth, and the system can interpolate different mouth shapes in between these two images by establishing a “smooth” space as between the two images (e.g., a continuous space).

The proposed conditional U-Net (G) takes as input a masked cropped (Mᵢ) image of source frame, along with a condition vector (lₘ) and generates a new infilled crop (x=G(Mᵢ,lₘ)) where generated mouth matches the given condition vector. In the dubbing process, latent codes are generated by VectorPuppet from audio and can then be used as input to U-Net to generate frames that match any given audio. Latent codes can also be extracted from any given image of a face and used as driving condition. This allows users to upload a video (for example) as driving condition for a set of frames where the resulting frames now match the uploaded performance. In this setting each frame of the given video is first passed through the trained mouth crop encoder generating a latent code (lₘ) for each frame. These latent codes can then be used as driving conditions to modify source footage to match uploaded performance.

Another interaction mode takes advantage of the smooth (i.e., continuous) latent space learned by during the training process. By smooth, it is meant that one can take the latent code of one mouth

$$( {l}_{m}^{a} ) ,$$

and the smoothly interpolate it to the latent code of another mouth

$$( {l}_{m}^{b} ) .$$

By interpolation, it is meant to be defined as finding the unit vector between the two latent code and stepping along that code by a user controlled magnitude. This yields a new latent code,

$${l}_{m}^{c} ,$$

between

$${l}_{m}^{a} and {l}_{m}^{b} ,$$

which when used as input to U-Net, generates a mouth shape that appears logically between the two original images. This interpolation allows a user to change a single frames mouth shape by moving a slider attached to a weight in the interpolation process,

$${l}_{m}^{c} = {l}_{m}^{a} + β \vert {l}_{m}^{a} - {l}_{m}^{b} \vert .$$

For example, the user could close a mouth slightly by interpolating the vector towards a more closed mouth image, or widen a mouth by interpolating towards a wider mouth image vector. The images used to generate latent codes can be user supplied, extracted from the content being dubbed, or taken from a library of mouth images.

In terms of the dubbing process, the architecture outlined above can be trained on a single identity and produce strong results as long as the video being trained on is of sufficient length and contains sufficient variation of mouth shapes/expressions. The exact length required has not been pinpointed, but Applicant has observed in testing success on 20 minutes of video.

Given that a target application lies in dubbing high-quality, production level content (e.g., feature films/commercials/tv) it is extremely unlikely that 20 minutes of footage, in the same setting that requires dubbing, will exist for any given project. To mitigate this technical limitation that occurs in practical scenarios, the approach can also utilize a hierarchical tuning strategy. For both Lip2Face and VectorPuppet, an approach includes training global models on diverse data, and then tuning them for a target identity or clip.

Hierarchical tuning will not directly affect the outcome but it reduces the time required to produce model weights that can produce that outcome. More specifically, hierarchical tuning strategy is a method of reducing total training time by gradually refining the dataset trained on. A model trained on Actor X for four hours is in a better position to learn the fine details of Actor X in a new movie than one that was trained on a wider set of identities. In the hierarchical tuning strategy, a global model is trained across all data available (e.g., to a post-production or special effects company). In the case of a series, one could train the global model on all clips of all identities in the given series. This global model would be used to initialize the weights of the identity tuning process. In identity tuning, the approach can now optimize the U-Net weights along with identity code but freeze the mouth crop encoder.

The clip model is initialized from the identity tuned model for identity in the given clip. In clip tuning, one can further optimize U-Net weights and identity code but once again keep the mouth crop encoder frozen.

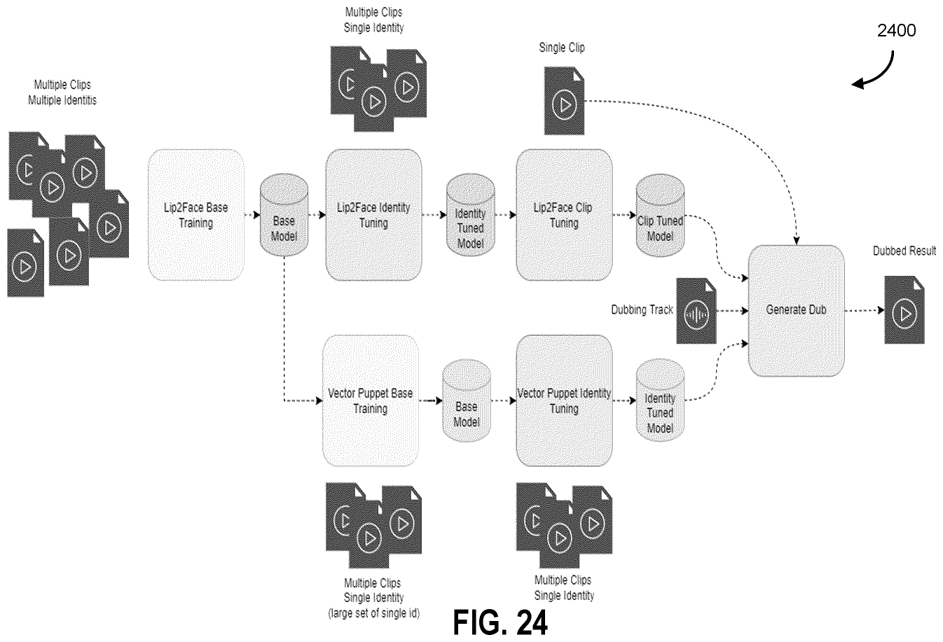

FIG. 24 is a process diagram, according to some embodiments. In particular, the process 2400 in FIG. 24 gives an overview of this process from training base models all the way to generating a result on a given clip.

It is important to note that once the Lip2Face base model is trained, the mouth crop encoder cannot be updated. As the Lip2Face model is conditioned on the specific implicit representation learnt by the mouth encoder, if one tunes the mouth crop encoder, then the “common language” between vector puppet and Lip2Face is broken and must be retrained. There may be an extreme case where, if all the weights of the model were reset and retrained, there will likely be a network to product similar results. However, the mouth encoder between the two models would not be compatible. Each encoder would produce entirely different distributions given the stochastic nature of gradient descent. Allowing the mouth encoder to update its weights does not guarantee it produces vectors in the same distribution as when it was initialized.

Additionally, a desired property of the mouth crop encoder is to encode only viseme information and not identity. Training on a diverse dataset of identities promotes this property as the encoder must learn what is common between all of them—the viseme. By allowing updating of the mouth crop encoder, the system can lose that property and overfit to a given identity, losing the ability to generalize to new driving vectors in test time.

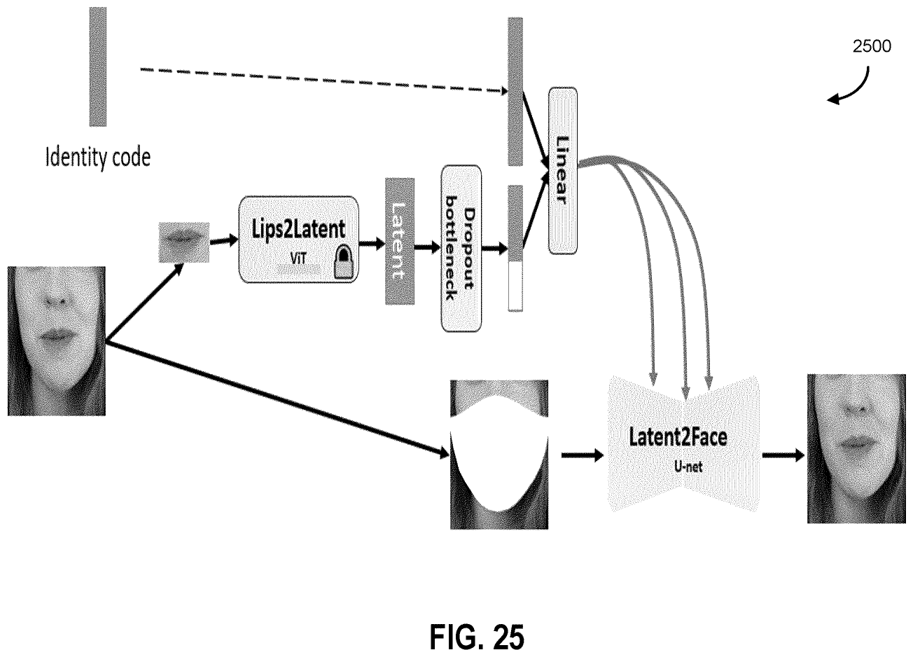

FIG. 25 is a diagram showing a locking of an encoder, according to some embodiments. In FIG. 25, a process 2500 is shown where the mouth crop encoder is locked during fine tuning of Lip2Face. Namely, the approach in this variation only allows updating of the U-Net and identity code, ensuring the driving signal remains fixed. The locking process includes setting the machine learning architecture parameters to be static and no longer being updated during back propagation.

In a variation, generative controls may be provided as part of a set of controllable parameters and options that can, for example, be controlled by a user or an artist to influence how the model operates. For example, both landmark and the mouth crop approach have the ability to intuitively influence output, and the mouth crop encoder can be configured to provide improved controllable outputs for the user. For example, where, before, the artist was able to modify landmarks in 3 dimensional space and see the effect on output (i.e., open mouth, move mouth), the user/artist can now make changes in mouth crop vector space by interpolating between given mouth shapes or replacing vectors with their own recorded performance.

Given the arithmetic properties, one can analogize the latent space to be similar to the StyleGAN latent space but instead restricted to visemes. In StyleGAN, one takes an image of man with glasses and subtract image of man, then add image of woman to get an image of woman with glasses. In a similar lens, the proposed approach can take two images, encode them and interpolate between them generating the images in between. This smooth interpolation (i.e., the interpolation is meaningful and when any embedding along the path is given to the generator, it produces a semantically meaningful output) has different variations/types of controls. For example, when there is the encoding of person with mouth open and another encoding of same person with mouth closed, blending between those vectors and generating the samples would appear as the mouth gradually closing.

Furthermore, a user can find similar visemes in datasets to offer alternatives. Users might select viseme from a “catalog” and drag a slider to “move” a generated mouth towards it. In some embodiments, the graphical user interface would be able to show incremental updates as the vector moves towards mouth shape allowing control on how “dramatic” the user wants change to be.

The crop vector space allows arithmetic operations between embeddings for interpolation (verified). More importantly, the output of vector puppet can at any time be replaced by the embedding of a given crop image. This allows interfaces where the user might be able to “drop” an image of target mouth shape into view to change the output to be more like target mouth.

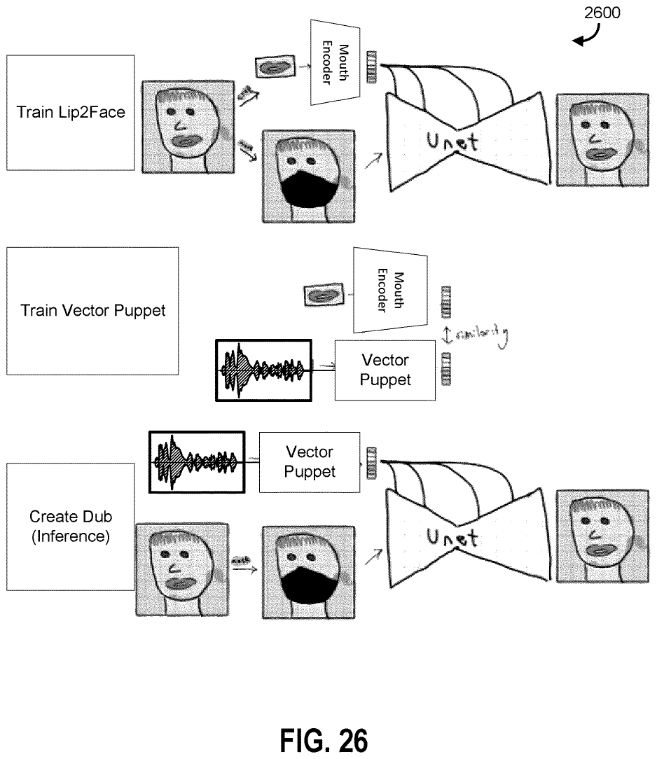

FIG. 26 is an alternate illustration 2600 of an example flow for using the approach for generatively creating a dub, according to some embodiments.

The system can be implemented as a special purpose machine, such as a dedicated computing appliance that can operate as part of or as a computer server. For example, a rack mounted appliance that can be utilized in a data center for the specific purpose of receiving input videos on a message bus as part of a processing pipeline to create output videos. The special purpose machine is used as part of a post-production computing approach to visual effects, where, for example, editing is conducted after an initial material is produced. The editing can include integration of computer graphic elements overlaid or introduced to replace portions of live-action footage or animations, and this editing can be computationally intense.

The special purpose machine can be instructed in accordance to machine-interpretable instruction sets, which cause a processor to perform steps of a computer implemented method. The machine-interpretable instruction sets can be affixed to physical non-transitory computer readable media as articles of manufacture, such as tangible, physical storage media such as compact disks, solid state drives, etc., which can be provided to a computer server or computing device to be loaded or to execute various programs.

In the context of the present disclosed approaches, the pipeline receives inputs for post-processing, which can include video data objects and a target audio data object. The system is configured to generate a new output video data object that effectively replaces certain regions, such as regions of the mouth regions. The target audio data object can be first decomposed to time-stamped audio tokens, which are mapped to phonemes and then corresponding visemes. Effectively, each time-stamped audio token can represent a mouth shape or a mouth movement that corresponds to the target audio data object.

As the original video has speech in an original language, the mouth and/or facial motions of the individual need to be adapted in the output video in an automated attempt to match the target audio data object (e.g., the target language track). As described herein, this process is difficult and impractical to conduct manually, and proposed herein are machine learning approaches that attempt to automate the generation of replacement video.

A first example of a special purpose machine can include a server that is configured to generate replacement output video objects based on parameter instruction sets that are disentangle expression and pose when controlling the operation of the machine learning network. For example, the parameter instruction sets can be based on specific visemes that correspond to a new mouth movement at a particular point in time that correspond to the target mouth movement in the target language of the desired output audio of the output video object. Optionally, the parameter instruction sets can be extended with additional parameters representing residual parameters.

In this example, the machine learning network has two sub-networks, a first sub network being a voice to lips machine learning model, and a second sub network being a lips to image machine learning model. These two models interoperate together in this example to reconstruct the frames to establish the new output video data object. The two models can be used together in a rough/fine reconstruction process, where an initial rough frame can be refined to establish a fine frame. In the reconstruction process, the models work together in relation to masked frames where inpainting can occur whereby specific parts of image frames are replaced, just in regions according to the masked frames (e.g., just over the mask portion).

The output, in some embodiments, can be instructions for inpainting that can be provided to a downstream system, or in further embodiments, replacement regions for the mask portions or entire replaced frames, depending on the configuration of the system. The pipeline computing components can receive the replacement output video or replacement frames, and in a further embodiment, these frames or video portions thereof can be assessed for quality control, for example, by indicating that the frames or video portions are approved/not approved. If a frame/video portion is not approved, in a further embodiment, the system can be configured to re-generate that specific portion and the disapproval can be utilized as further training for the system. In some embodiments, an iterative process can be conducted until there are no disapproved sections and the all portions or frames have passed the quality control process before a final output video data object is provided to a next step in the post-processing pipeline.

The post-processing pipeline can have multiple processors or systems operating in parallel. For example, a video may be received that is a video in an original language, such as French. Audio tracks may be desired in Spanish, English, German, Korean, Chinese, Japanese, Malaysian, Indonesian, Swahili, etc. Each of these target audio tracks can be obtained, for example, by local voice talent, computer voice synthesis using translation programs, etc. The system can be tasked in post-production to create a number of videos in parallel where the mouths are modified to match each of these target audio tracks. Each generated video can then undergo the quality control process until a reviewer (e.g., a reviewer system or a human reviewer) is satisfied with the output.

A number of variations are described below in respect of modified machine learning architectures that can be utilized in some variant embodiments. In particular, an additional phoneme head is proposed in one embodiment that is used for predictions, such that two phoneme heads are used, one for learning fine details, and a fixed encoder to avoid catastrophic forgetting.

These approaches are propose below as Applicants were able to obtain improved results in terms of articulation across different languages, as well as practical improvements for supporting changes of speed and cadence of the speaker.

A new stage, blender, is also described below that blends a face prediction back into a source frame, which may provide an improvement over alternate infilling approaches as proposed in previous mechanisms described by Applicants.

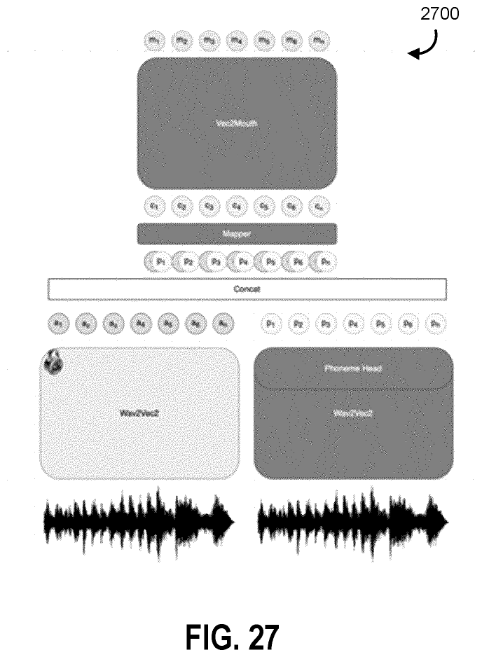

FIG. 27 shows an example 2700 of a modified architecture using Wav2Vec2.0. Voice2Lip relies on Wav2Vec2, or any audio encoder, pre-trained model to produce vectors representing audio. Wav2Vec2 is a foundational model trained to map audio to text, the vector space created by the model contains rich representation of the phonemes being spoken in the given audio. For earlier versions of Voice2Lip, the model was trained to map Wav2Vec2.0 audio tokens to Lip2Face mouth vectors. The model produced good articulation but struggled in fast speech and would often produce “average” mouth shapes instead of hitting the specific visemes. It was especially noticeable with bilabial stops (/b /p /m) and labiodental phonemes (/f /v).

The blue box “Wav2Vec2” is the same audio encoder as used in the previous model. However there is a second “phoneme” head that is trained on top of Wav2Vec2 to predict the phoneme spoken. The tokens predicted by Wav2Vec2 are simply vectors, while the phoneme head predicts logits for probability a given token maps to a given phoneme. This addition is a more explicit and guided signal on the phoneme in context of the broader audio. This phoneme head helps give additional information to resolve ambiguity in the raw Wav2Vec2 tokens. The goal is to allow the learning of fine details in the phoneme head, while the audio encoder helps avoid catastrophic forgetting of the original 960 h Wav2Vec2 dataset. With this change, there are improvements to articulation across all languages and better support for changing in speed and cadence of the speaker.

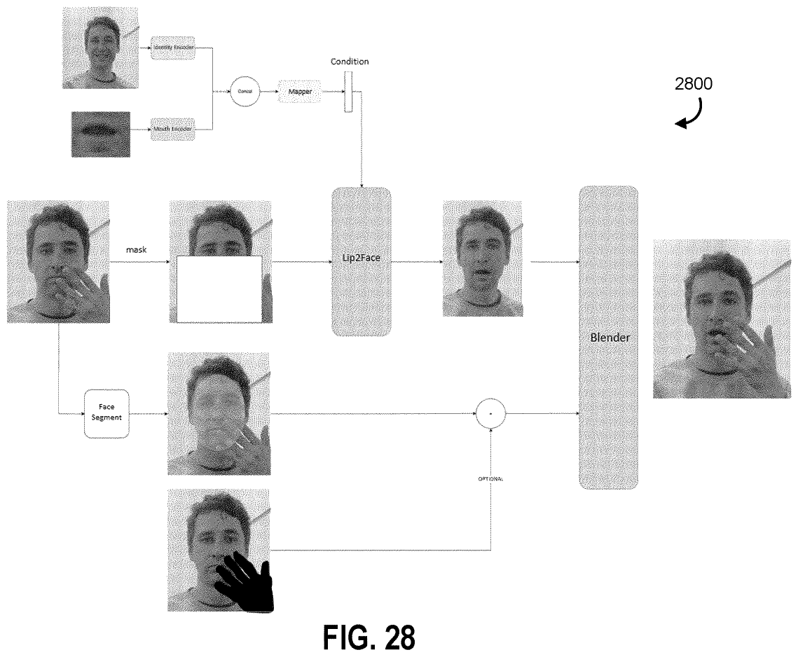

FIG. 28 is an example diagram 2800 showing the use of a Blender for Lip2Face. The Blender is a new stage in Lip2Face training that address three core problems: (1) dynamic backgrounds are not well preserved—users can see flicker/poor reconstructions close to face if background is dynamic; (2) masking introduces “viseme leakage” if tight to face; and (3) occluding objects cannot be well reconstructed. In the previous model, Lip2Face is tasked with infilling a masked image with the correct mouth shape given a driving condition. However, in the case of occlusions, this problem is ambiguous since the network will inherently learn a mapping from the driving condition to drawing back occlusion pixels. In practice this ambiguity resolves as poor reconstruction of the occluding object along with flickering of the occlusion in predictions.

The output of the first model is given to Blender. This output typically has poor background detail and blurred occlusions (or none at all). Blender is also given a masked input of the source frame. The face is masked out, while the background and any occluding objects are visible. Blender is then tasked with reconstructing the source image from the inputs. Blender learns to copy texture from the masked background reference image where visible, and take texture from the predicted input where not. In the boundaries between these two, blender learns to “blend” the two regions together creating a seamless final outcome.

The “occlusion mask” shown at bottom with the black hand is an optionally supplied mask by the user. This mask could also be auto generated by any interface like SAM or similar. In this example, users can upload a mask video directly that matches the duration of source video being dubbed. Other embodiments can automatically create this mask video for a seamless occlusion workflow.

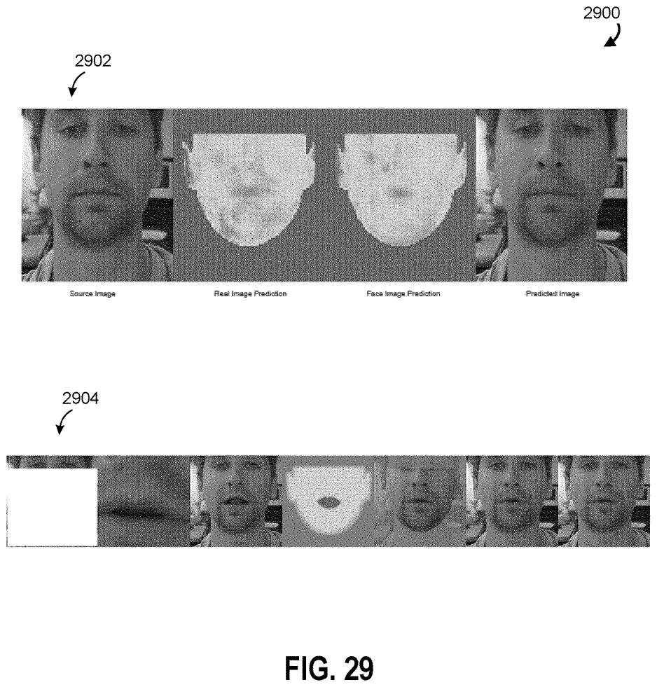

FIG. 29 is an example 2900 of the masking mechanisms using the blender approach described herein in a variant approach. Using the variant blender approach, the Lip2Face model no longer has to produce perfect textures in the background. This provides more flexibility in weight losses and focuses training on key regions, such as the mouth and face. There are two main masking mechanisms. First, masking the discriminator losses to localize to the face region. Second, weighting reconstruction pixel losses by the face. The example 2902 shows discriminator masking where only the predictions within the face mask are used in loss calculation. Another example 2904 shows face weight loss, where lips are weighted highest, then face, then boundary, and finally the background is given a constant weight to ensure stability.

These are variations of masking that can be utilized in different contexts, and are contemplated in various alternate embodiments described herein.

Variations of computing architecture are proposed herein. For example, in an exemplar embodiment, a single U-Net is utilized that exhibits strong performance in experimental analysis.

Variations of masking approaches are also proposed, for example, an improved mask that extends the mask region into the nose region instead of just below the nose, which was also found to exhibit strong performance in experimental analysis.

Applicant notes that the described embodiments and examples are illustrative and non-limiting. Practical implementation of the features may incorporate a combination of some or all of the aspects, and features described herein should not be taken as indications of future or existing product plans.

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended embodiments are intended to include within their scope such processes, machines, manufacture, compositions of matter, means, methods, or steps.

As can be understood, the examples described above and illustrated are intended to be exemplary only.

1. A computer implemented system for generating a replacement mouth region corresponding to a target audio track for lip dubbing a base video in a first language to match a second language in the target audio track, the computer implemented system including a processor coupled to computer memory, the processor configured to:
provide a mouth encoder machine learning data architecture that yields a vector describing a viseme of a given mouth crop for use as a driving condition of a unet machine learning architecture, the mouth encoder machine learning data architecture receiving a mouth crop and producing a latent code;
provide an identity code book data object representing a learnable N×K matrix, where N is a number of identities in a training set, and K is a dimensionality of each identity code;
during training, extract a identity code from the identity code book data object according to an identity of an example frame;
update the code on a backward pass of the mouth encoder machine learning data architecture;
provide, to the unet machine learning architecture, a concatenation of the identity code and a latent code corresponding to the given mouth crop; and
utilize the unet machine learning architecture to generate the replacement mouth region.

2. The system of claim 1, wherein the concatenation is first passed through a dense layer to resize the concatenation.

3. The system of claim 1, wherein the processor is further configured to apply a nested dropout to mouth crop latent codes.

4. The system of claim 3, wherein the nested dropout includes randomly generating an index i that is smaller than the code length and zeroing out all entries with an index larger than i.

5. The system of claim 1, wherein a training dataset is generated from videos by extracting audio and mouth crop embeddings for each frame.

6. The system of claim 1, wherein vector to face model training occurs before vector puppet training.

7. The system of claim 6, wherein mouth latent codes are generated from a trained encoder, and a vector puppet model architecture is trained to produce vectors Is from audio that match frame extracted vectors lₘ.

8. The system of claim 7, wherein a L₂ loss between lₛ and lₘ is utilized to enforce similarity.

9. The system of claim 8, wherein the mouth encoder machine learning data architecture includes both a global model and one or more individual tuned models that are refined using a hierarchical tuning strategy.

10. The system of claim 9, wherein the global model is trained on diverse data, and the one or more individual tuned models are trained for a target identity or clip.

11. A computer implemented method for generating a replacement mouth region corresponding to a target audio track for lip dubbing a base video in a first language to match a second language in the target audio track, the method comprising:
providing a mouth encoder machine learning data architecture that yields a vector describing a viseme of a given mouth crop for use as a driving condition of a unet machine learning architecture, the mouth encoder machine learning data architecture receiving a mouth crop and producing a latent code;
providing an identity code book data object representing a learnable N×K matrix, where N is a number of identities in a training set, and K is a dimensionality of each identity code;
during training, extracting a identity code from the identity code book data object according to an identity of an example frame;
updating the code on a backward pass of the mouth encoder machine learning data architecture;
providing, to the unet machine learning architecture, a concatenation of the identity code and a latent code corresponding to the given mouth crop; and
utilizing the unet machine learning architecture to generate the replacement mouth region.

12. The method of claim 11, wherein the concatenation is first passed through a dense layer to resize the concatenation.

13. The method of claim 11, further comprising applying a nested dropout to mouth crop latent codes.

14. The method of claim 13, wherein the nested dropout includes randomly generating an index i that is smaller than the code length and zeroing out all entries with an index larger than i.

15. The method of claim 11, wherein a training dataset is generated from videos by extracting audio and mouth crop embeddings for each frame.

16. The method of claim 11, wherein vector to face model training occurs before vector puppet training.

17. The method of claim 16, wherein mouth latent codes are generated from a trained encoder, and a vector puppet model architecture is trained to produce vectors ls from audio that match frame extracted vectors lₘ.

18. The method of claim 17, wherein a L₂ loss between lₛ and lₘ is utilized to enforce similarity.

19. The method of claim 18, wherein the mouth encoder machine learning data architecture includes both a global model and one or more individual tuned models that are refined using a hierarchical tuning strategy.

20. (canceled)

21. A non-transitory computer readable medium or computer program product storing machine interpretable instructions, which when executed, cause a computer processor to perform the steps of a method for generating a replacement mouth region corresponding to a target audio track for lip dubbing a base video in a first language to match a second language in the target audio track, the method comprising:
providing a mouth encoder machine learning data architecture that yields a vector describing a viseme of a given mouth crop for use as a driving condition of a unet machine learning architecture, the mouth encoder machine learning data architecture receiving a mouth crop and producing a latent code;
providing an identity code book data object representing a learnable N×K matrix, where N is a number of identities in a training set, and K is a dimensionality of each identity code;
during training, extracting a identity code from the identity code book data object according to an identity of an example frame;
updating the code on a backward pass of the mouth encoder machine learning data architecture;
providing, to the unet machine learning architecture, a concatenation of the identity code and a latent code corresponding to the given mouth crop; and
utilizing the unet machine learning architecture to generate the replacement mouth region.

22.-30. (canceled)
